(19) United States
(12) Patent Application Publication
(10) Pub. No.: US 2010/0205108 A1
(43) Pub. Date: Aug. 12, 2010

(54) Credit and market risk evaluation method

(76) Inventor: Johnathan C. Mun, Pleasanton, CA (US)

Correspondence Address: Johnathan C. Mun, 4101F Dublin Blvd., Ste. 425, Dublin, CA, 94568, US

(21) Appl. No.: 12/378,174

(22) Filed: Feb. 11, 2009

(51) Int. Cl. G06Q 40/00; G06N 5/02

(52) U.S. Cl. 705/36 R; 706/52

(57) ABSTRACT

A method and system allowing banks and financial institutions the capability to perform advanced risk analyses that central banks and banking regulators require, such that the banks are in compliance with the Basel II Accord requirements. This system is both a standalone and server-based set of software modules and advanced analytical tools that is used to quantify and value credit and market risk, as well as forecast future outcomes of economic and financial variables, and generate optimal portfolios that mitigate risks.

### COPYRIGHT AND TRADEMARK NOTICE

A portion of the disclosure of this patent document contains materials subject to copyright and trademark protection. The copyright and trademark owner has no objection to the facsimile reproduction by anyone of the patent document or the patent disclosure, as it appears in the U.S. Patent and Trademark Office patent files or records, but otherwise reserves all copyrights whatsoever.

### BACKGROUND OF THE INVENTION

The present invention is in the field of finance, economics, math, and business statistics, and relates to the modeling and valuation of credit and market risk to banks and financial institutions, allowing these institutions to properly assess, quantify, value, diversify, and hedge their risks. Banks and financial institutions have many risks. The critical sources of risk are credit and market risk. A bank is a monetary intermediary that receives its funds from individuals and corporations depositing money in return for the bank providing a certain interest rate (i.e., savings accounts, certificate of deposits, checking accounts, and money market accounts), and the bank in turn takes these deposited funds and invests them in the market (i.e., corporate bonds, stocks, private equity, and so forth) and provides loans to individuals and corporations (i.e., mortgages, auto loans, corporate loans, et cetera) where in return, the bank receives periodic repayments from these debtors with some rate of return. The bank makes its profits from the spread or difference between the received rate of return and the paid out interest rates, less any operating expenses and taxes. The risks that a bank face include credit risk (debtors or obligors default on their loan and debt repayments, file for bankruptcy or pays off their debt early through a refinance somewhere else) and market risk (invested assets such as corporate bonds and stocks earn less than expected returns), thereby reducing the profits to the bank. The problem arises when such risks are significant enough that it compromises the financial strength of the bank, and thus reduces its ability to be a trusted financial intermediary to the public. The repercussions of a bank collapsing are significant to the economy and to the general public. Therefore, bank regulators have required that banks and other financial institutions apply risk analysis and risk management techniques and procedures to ensure their financial viability. These regulations require that banks quantify their risks, including understanding what their values at risk are (how much of their asset holdings can they potentially lose in a catastrophic market downturn situation), what impacts the credit risks might be of debtors defaulting (probabilities of default on different classes of loans and credit lines, the total financial exposure to the bank if default occurs, the frequency of these defaults, and expected losses and unexpected losses at default), what impacts market risks might have on the bank's ability to stay solvent (impacts of changes in interest rates, foreign exchange rates, stocks and bond market forecasts, and returns on other invested vehicles). These are extremely difficult tasks for banks to undertake and this present invention is a method that allows banks and other financial institutions to quantify these risks based on advanced analytical techniques that are integrated in a system that helps model these values as well as run simulations to forecast and predict the probabilities of occurrence and impact of these occurrences. The method also includes the ability to take a bank's existing database and extract the data into meta-tables for analysis in a fast and efficient way, and return the results back in a report or database format. This is valuable to banks because a bank with its many branches will have a significant amount of financial transactions per day, and the ability to apply multi-core processor and server-based technology to extract large data sets from large databases is critical.

The field of risk analysis is large and complex, and banks are being called on more and more to do a better job at quantifying and managing their risks, both by investors and regulators alike. This invention focuses on the quantification and valuation of risk within the banking and financial sectors by helping these institutions analyze multiple datasets quickly and effectively, returning powerful results and reports that allow executives and decision makers make midcourse corrections and changes to their asset and liability holdings. As such, risk analyses and proper decision-making in banks are highly critical to prevent bankruptcies, liquidity crises, credit crunches and other banking meltdowns.

The related art is represented by the following references of interest.

U.S. Pat. No. US 2007/0143197 A1 issued to Jackie Ineke, et al on Jun. 21, 2007 describes the elements of credit risk reporting for satisfying regulatory requirements, including the estimation of the future value and profitability of an asset, predicting this asset's direction of change, breakeven analysis, financial ratios and metrics, for the purposes of creating or designing a financial asset. The Ineke application is irrelevant to the claims of the current invention application as it does not suggest the method of how to quantitatively value market and credit risk, provide data extraction and linking from existing databases, applying internal optimization routines to determine the probability of default of a credit issue, the application of maximum likelihood approaches, multiple layers of data analysis and software integration or the application of Monte Carlo methods to solving and valuing credit and market risk.

U.S. Pat. No. US 2006/0047561 A1 issued to Charles Nicholas Bolton, et al on Mar. 2, 2006 describes a framework for operational risk management and control, with roles and responsibilities of individuals in an organization and linking these responsibilities to operational risk control and certification of this control system, including the qualitative assessments of these risks for regulatory compliance. The Bolton application is irrelevant to the claims of the current invention application as it does not suggest the method of how to quantitatively value market and credit risk, applying data extraction and linking from existing databases, applying internal optimization routines to determine the probability of default of a credit issue, the application of maximum likelihood approaches, multiple layers of data analysis and software integration or the application of Monte Carlo methods to solving and valuing credit and market risk, and the Bolton invention is strictly on the application of operational risk analysis which is not what this current invention is about.

U.S. Pat. No. US 2006/0235774 A1 issued to Richard L. Campbell, et al on Oct. 19, 2006 describes operational risk management and control, specifically for the application of accounting controls in the general ledger, to determine the operational losses and loss events in a firm. The Campbell application is irrelevant to the claims of the current invention application as it does not suggest the method of how to quantitatively value market and credit risk, provide data extraction and linking from existing databases, applying internal optimization routines to determine the probability of default of a credit issue, the application of maximum likelihood approaches, multiple layers of data analysis and software integration or the application of Monte Carlo methods to solving and valuing credit and market risk.

U.S. Pat. No. US 2007/0050282 A1 issued to Wei Chen, et al on Mar. 1, 2007 describes financial risk mitigation strategies by looking at the allocation of financial assets and instruments in a portfolio optimization model, using risk mitigation computations and linear programming as well as simplex algorithms. The Chen application in using such techniques and weighting assets and finding discount factors are irrelevant to the claims of the current invention application as it does not suggest the method of how to quantitatively value market and credit risk, provide data extraction and linking from existing databases, applying internal tabu search and reduced gradient optimization search routines to determine the probability of default of a credit issue, the application of maximum likelihood approaches, multiple layers of data analysis and software integration or the application of Monte Carlo methods to solving and valuing credit and market risk.

U.S. Pat. No. US 2004/0243719 A1 issued to Eyal Shavit, et al on Oct. 2, 2008 describes whether a credit or loan should be approved by a financial institution, by looking at the type of loan, the borrower's creditworthiness, interest rate in the lending order, desired risk profile of the lender, end term, and other borrower's qualitative factors, as well as a system to track borrowers' application, change of status, address and other application information. The present invention application is a set of analysis applied for the entire bank as a whole and not on individual loans or credit, therefore the Shavit application is irrelevant to the claims of the current invention application as it does not suggest the method of how to quantitatively value market and credit risk, provide data extraction and linking from existing databases, applying internal optimization routines to determine the probability of default of a credit issue, the application of maximum likelihood approaches, multiple layers of data analysis and software integration or the application of Monte Carlo methods to solving and valuing credit and market risk.

U.S. Pat. No. US 2008/0107161 A1 issued to Satoshi Tanaka, et al on Jun. 3, 2004 describes a detailed credit lending system, to whether issue or approve a specific loan or credit line to a borrower or not. The Tanaka application is irrelevant to the claims of the current invention application as it does not suggest the method of how to quantitatively value market and credit risk, data extraction and linking from existing databases, applying internal optimization routines to determine the probability of default of a credit issue using maximum likelihood methods, multiple layers of data analysis and software integration or the application of Monte Carlo methods to solving and valuing credit and market risk for the entire bank or financial institution as a whole and not on specific borrowers only.

U.S. Pat. No. US 2008/0052207 A1 issued to Renan C. Paglin on Feb. 28, 2008 describes what happens after a debt or credit issue is provided and how to service these loans and credit issues, specifically on low-risk debt securities (referred to as LITE securities) that are less liquid and linked to specific country or sovereign securities, and are specifically related to foreign exchange and currency risks. The Paglin application is irrelevant to the claims of the current invention application as it does not suggest the method of how to quantitatively value market and credit risk on all types of securities and are restricted to LITE securities, data extraction and linking from existing databases, applying internal optimization routines to determine the probability of default of a credit issue, the application of maximum likelihood approaches, multiple layers of data analysis and software integration or the application of Monte Carlo methods to solving and valuing credit and market risk.

### SUMMARY OF THE INVENTION

Risk and uncertainty abound in the business world and impact business decisions and ultimately affects the profitability and survival of the corporation. This effect is more so in the financial sector, specifically multinational banks, which are exposed to multiple sources of risk such as credit risk (obligors defaulting on their mortgages, credit lines and loans) and market risk (uncertainty of profits and risk of losses in financial investments, interest rates, returns on invested assets, inflation rates, and general economic conditions). In fact, the Bank of International Settlements located in Switzerland, together with several central banks around the world, created the Basel Accords and Basel II Accords, requiring banks around the world to comply with certain regulatory risk requirements and standards.

The present invention, with its preferred embodiment encapsulated within the Risk Analyzer (RA) software, is applicable for the types of analyses that central banks and banking regulators require for multinational and larger banks around the world, to be in compliance with the Basel II regulatory requirements. RA is both a standalone and server-based set of software modules and advanced analytical tools that are used in a novel and new integrated business process that links to various banking databases and data sources, to quantify and value credit and market risk, as well as forecast future outcomes of economic and financial variables, and generate optimal portfolios that mitigate risks.

### SUMMARY OF THE INVENTION

Risk and uncertainty abound in the business world and impact business decisions and ultimately affects the profitability and survival of the corporation. This effect is more so in the financial sector, specifically multinational banks, which are exposed to multiple sources of risk such as credit risk (obligors defaulting on their mortgages, credit lines and loans) and market risk (uncertainty of profits and risk of losses in financial investments, interest rates, returns on invested assets, inflation rates, and general economic conditions). In fact, the Bank of International Settlements located in Switzerland, together with several central banks around the world, created the Basel Accords and Basel II Accords, requiring banks around the world to comply with certain regulatory risk requirements and standards.

The present invention, with its preferred embodiment encapsulated within the Risk Analyzer (RA) software, is applicable for the types of analyses that central banks and banking regulators require for multinational and larger banks around the world, to be in compliance with the Basel II regulatory requirements. RA is both a standalone and server-based set of software modules and advanced analytical tools that are used in a novel and new integrated business process that links to various banking databases and data sources, to quantify and value credit and market risk, as well as forecast future outcomes of economic and financial variables, and generate optimal portfolios that mitigate risks.

### BRIEF DESCRIPTION OF THE DRAWING

FIG. 01 illustrates the three layers of RA, with the business logic, the data access layer, and the presentation layer.

FIG. 02 illustrates the process map of computing a default probability of a debt or credit line.

FIG. 03 illustrates the process map of computing the risk or volatility of a debt, credit line, investment vehicle, asset or liability.

FIG. 04 illustrates the process map of computing exposure at default of a portfolio of debt or credit lines.

FIG. 05 illustrates the process map of computing loss given default of a debt or credit line.

FIG. 06 illustrates the process map of computing a default probability of a debt or credit line of individuals or retail loans.

FIG. 07 illustrates the process map of computing a portfolio's value at risk, the amount that a bank or financial institution's portfolio of assets or liabilities is at risk given a certain probability and number of holding days.

FIG. 08 illustrates the process map of computing the expected and unexpected losses of a portfolio of assets and liabilities by combining the default probability, exposure at default, loss given default, and value at risk.

FIG. 09 illustrates the data mapping technology underlying the invented system, and how data tables from various sources and databases are linked and interconnected.

FIG. 10 illustrates the process map of forecasting market risk variables such as interest rates, returns on invested assets, inflation rates, and other economic and financial instruments.

FIG. 11 illustrates the system's main user interface for the operator or user, in accessing the various credit risk methodologies.

FIG. 12 illustrates the system's main user interface for the operator or user, in accessing the various market risks and forecasting methodologies.

FIG. 13 illustrates the system's various data input methods in linking existing data tables and databases, using manual inputs, providing the capabilities of computing and creating new data variables, setting simulation assumptions, and model fitting existing data to various mathematical and statistical distributions.

FIG. 14 illustrates the system's interconnectivity capabilities and mapping/linking approaches to various database systems such as Excel, Oracle Financial Data Model, SQL Server, as well as other data types and models.

FIG. 15 illustrates the manual data input capabilities of manually entering required input data or uploading data files into the system.

FIG. 16 illustrates the system's data computation process of using existing data variables or numerical inputs to generate new variables.

FIG. 17 illustrates the system's process of setting up various statistical distributions of an input variable for running simulations.

FIG. 18 illustrates the system's process of data model fitting of multiple data points to various statistical distributions of an input variable for running simulations.

FIG. 19 illustrates the system's variable management process and the portfolio management process of multiple models and analytics.

FIG. 20 illustrates the Risk Modeler module in the system, where over 600 models and valuation techniques are employed.

FIG. 21 illustrates the Stochastic Risk Optimizer module where a portfolio of assets, liabilities or decisions variables can be optimized. The various optimization methods are shown.

FIG. 22 illustrates the Stochastic Risk Optimizer module where a portfolio of assets, liabilities or decisions variables can be optimized. Some decision variables to be optimized are shown.

FIG. 23 illustrates the Stochastic Risk Optimizer module where a portfolio of assets, liabilities or decisions variables can be optimized. Some sample constraints to the problem are shown here.

FIG. 24 illustrates the Stochastic Risk Optimizer module where a portfolio of assets, liabilities or decisions variables can be optimized. The simulation statistics interface is shown here.

FIG. 25 illustrates the Stochastic Risk Optimizer module where a portfolio of assets, liabilities or decisions variables can be optimized. The objective to be solved in the problem is shown.

### DETAILED DESCRIPTION OF THE INVENTION

The preferred embodiment of the present invention is within a set of three software modules, named Risk Analyzer, Risk Modeler, and Stochastic Risk Optimizer. Each module has its own specific uses and applications. For instance, the Risk Analyzer is used to compute and value market and credit risks for a bank or financial institution with the ability to perform Monte Carlo simulations, perform forecasting, fitting of existing data, linking from and exporting to existing databases and data files. The Risk Modeler, in contrast, has a set of over 600 copyright protected models that are used to return valuation and forecast results from multiple categories of functions and applications. Finally, the Stochastic Risk Optimizer is used to perform static, dynamic and stochastic optimization on portfolios and making strategic and tactical allocation decisions using optimization techniques.

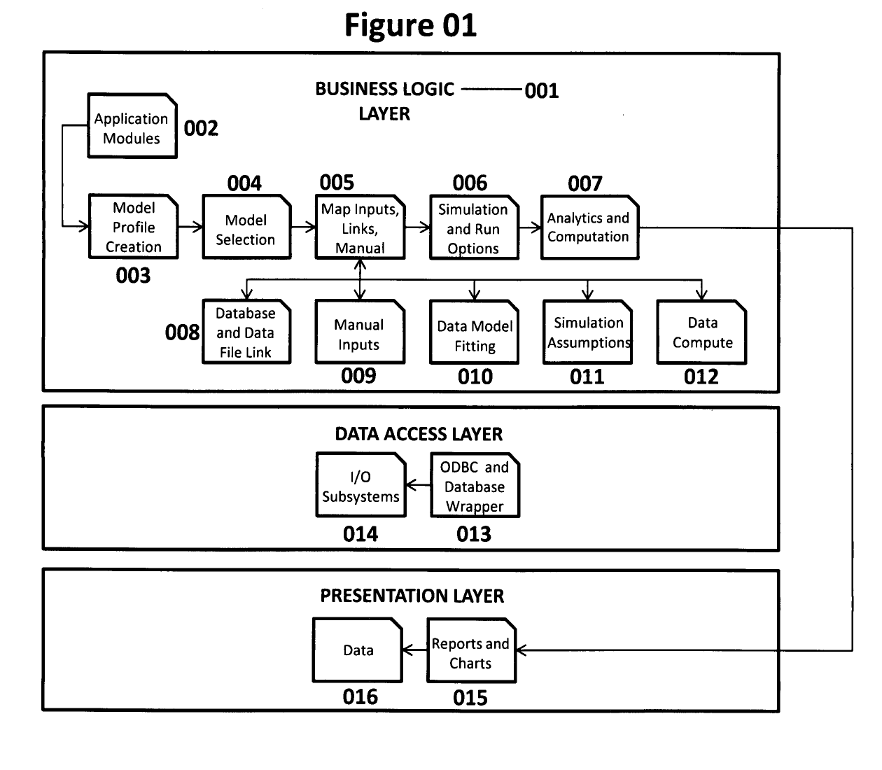

FIG. 01 illustrates the underlying infrastructure of the present invention, which has three layers, the business logic layer 001 which contains the application modules 002, that is, the location of the mathematical and financial models, where the user first creates a profile 003 that stores all the input assumptions, then selects the relevant 004 model to run. When the model is selected, the system automatically requests that the required input parameters be mapped 005. Several methods exist for the user at this point to decide where the input data comes from, whether through some existing data files or database 008 or manual inputs through directly typing data into the software 009 or using existing data to fit into mathematical distributions through statistical fitting routines 010, or without the use of existing data, to set Monte Carlo simulation assumptions 011, or a combination of these approaches through a data compute module 012 by modifying existing variables. If database or data tables or data files are used and linked in the business logic layer 001, then the method accesses the data access layer through calling a proprietary database wrapper 013 and input-output (I/O) subsystems 014. Upon completing the variable mapping step 005, the user then sets up the simulation and run options 006, then the analytics and computations occur 007, and generates the relevant reports and charts 015 as well as allowing the computed results to be extracted as flat text files or data tables back into the database 016 as new variables.

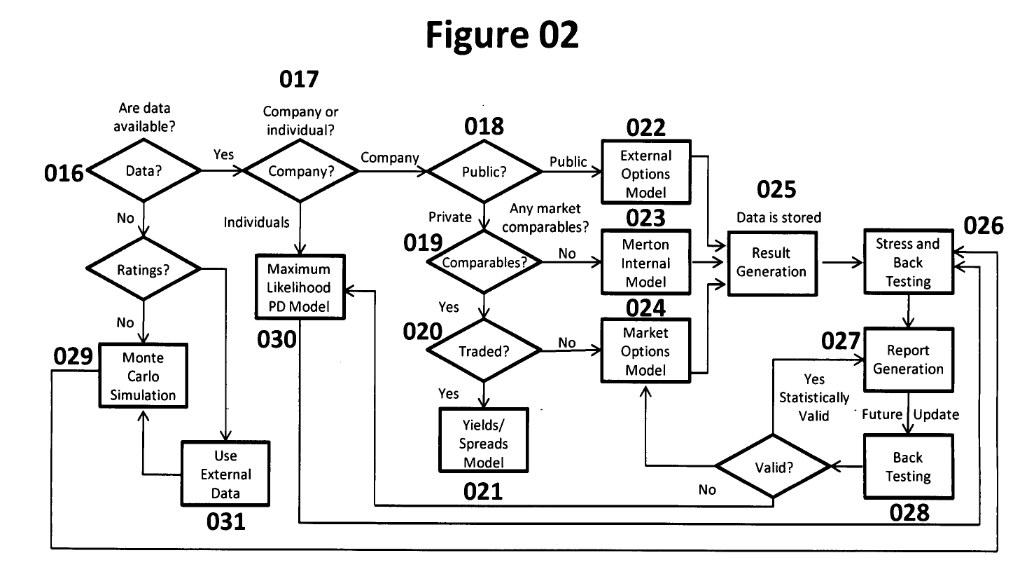

FIG. 02 illustrates an example of the system's computation of credit probability of default, starting with whether there exists historical data 016, and if the analysis is on a company 017 that is public 018 or private 019. If the entity to be analyzed is publicly traded, the system method applies an external options probability of default model 022, computes and generates the results 025 and allows future back testing 026 in the future and generate results reports 027, and further back testing 028 if required. If the company to be analyzed is privately held without market comparable firms, we apply the Merton internal model 023, versus a market options model 024 if broad-based market comparables exist. In contrast, is there are traded investments like bonds, a yields/spread model 021 is used in the system. If the entity to be analyzed is an individual instead, the maximum likelihood model is applied 030, versus external data sets are used 031, or simulation is applied if no external data exists 029.

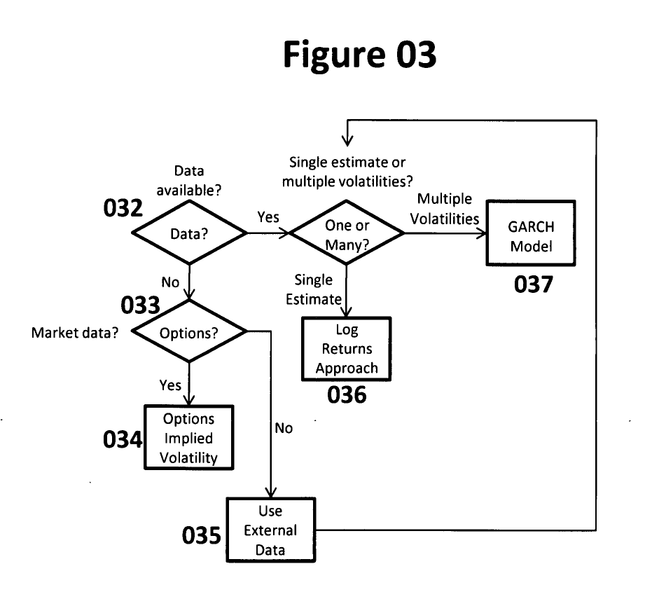

FIG. 03 illustrates how the risk or volatility of an asset or liability is computed. If commodity or stock prices exist 032 then either the GARCH (generalized autoregressive conditional heteroskedasticity) model 037 is applied or the log cash flow returns approach 036 depending if a single volatility of a series of volatilities is required. If these time-series data of stock, asset, interest rates, or commodities are not available, then if there are comparable options being traded on the entity 033, we apply the options implied volatility models 034 or use external data 035 otherwise.

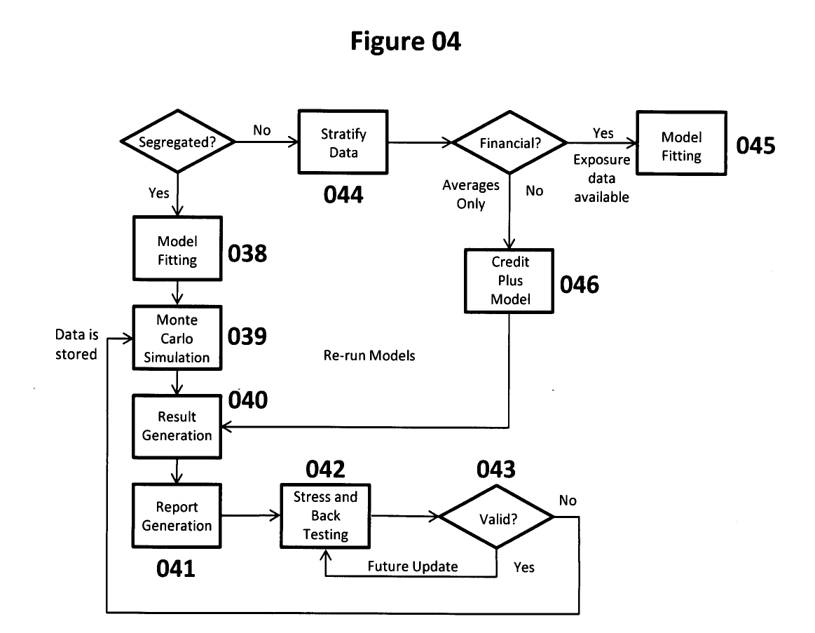

FIG. 04 illustrates the system's exposure at default computations where depending if the bank's data are already stratified into different groups, we can perform a statistical distributional fitting 038, or perform the stratification first and then perform the fitting 045. If the data are lumped into groups, the system applies a credit plus model 046 to generate the results 040 and appropriate reports 041, with an opportunity for stress and back testing 042 over time to determine if credit risks have changed or migrated over time 043, and if so, we would re-run a simulation on the inputs to determine the impacts of the risk changes 039.

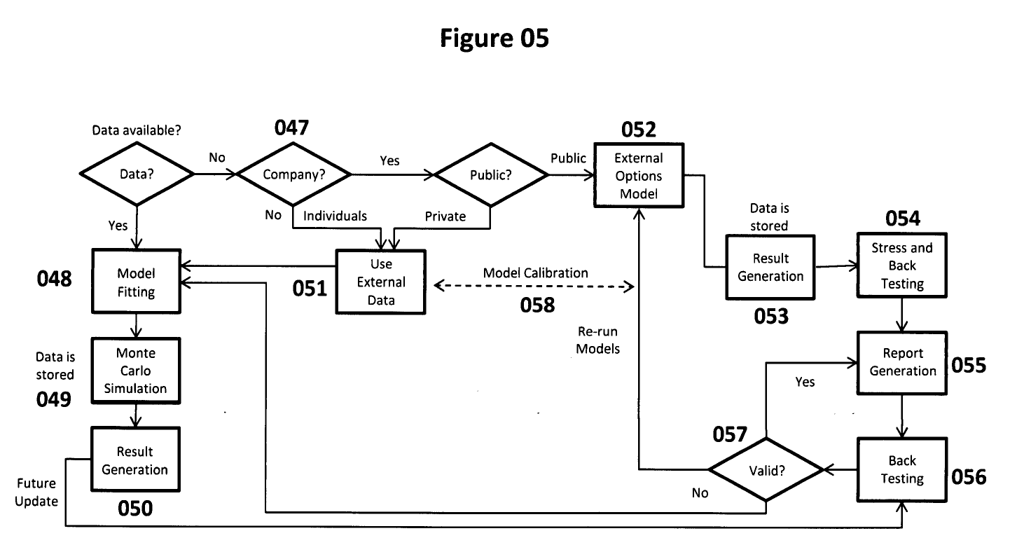

FIG. 05 illustrates the loss given default of a credit or debt. That is, how much on average will a credit or debt default be worth to a bank? Depending if the analysis is on a company 047 that is publicly traded, the external options probability of default model is used 052, results are computed and generated 053, stress testing is performed on the results 054, and the report is generated 055, with the opportunity for future back testing 056 if required to determine if credit risk migration has occurred 057 then the analysis is re-run 052 and the model can be manually calibrated by the user if required 058 using external data sources 051. These external data are then fitted to statistical distributions 048 and simulation is run 049 thousands to millions of times to generate the relevant reports 050.

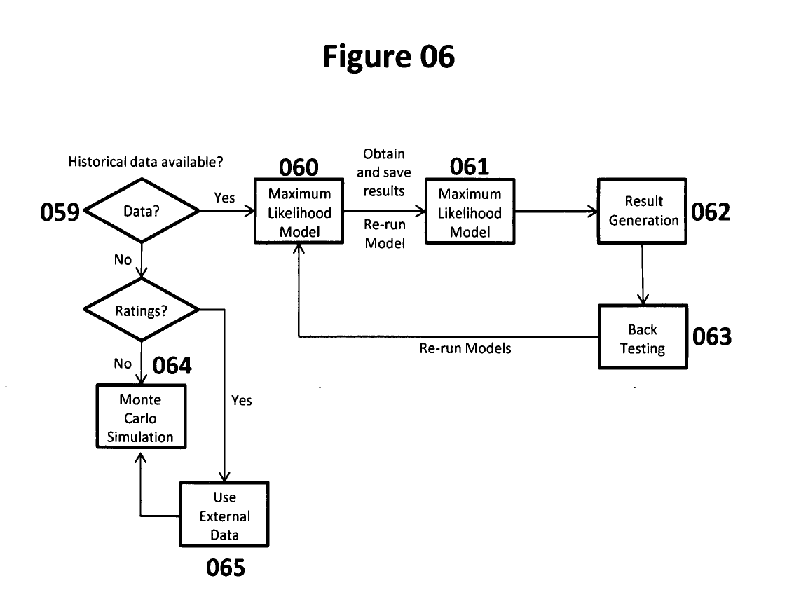

FIG. 06 illustrates the process when the target analyzed is an individual. If historical data exist 059 on individual debt, then a maximum likelihood method 060 is applied and re-run after the results are filtered 061, before results are generated 062, with the ability for the method to be back tested 063 and re-run and calibrated in the future 060. In contrast, if no data exist then a simulation 064 approach or external data can be obtained and run 065.

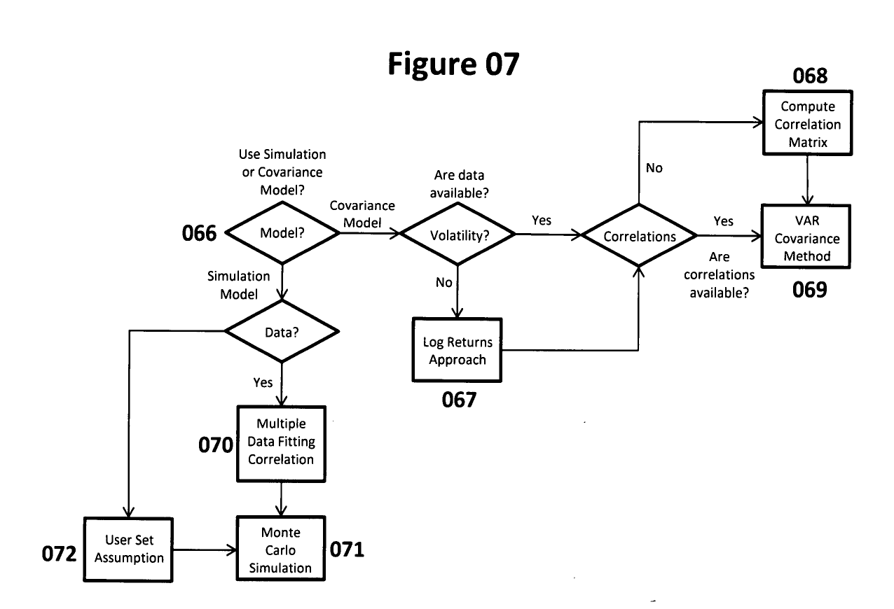

FIG. 07 illustrates a value at risk method 066 where the model can apply both mathematical computations 069 and simulation 071 to determine the value that a bank's portfolio is at risk given some probability of occurrence for a specific time horizon, accounting for cross correlations 068 among the different debt and credit lines in the portfolio. The model can be calibrated using existing data to compute the risk volatility measures 067 or fitted to statistical distributions 070, or based on a user's customized assumptions 072.

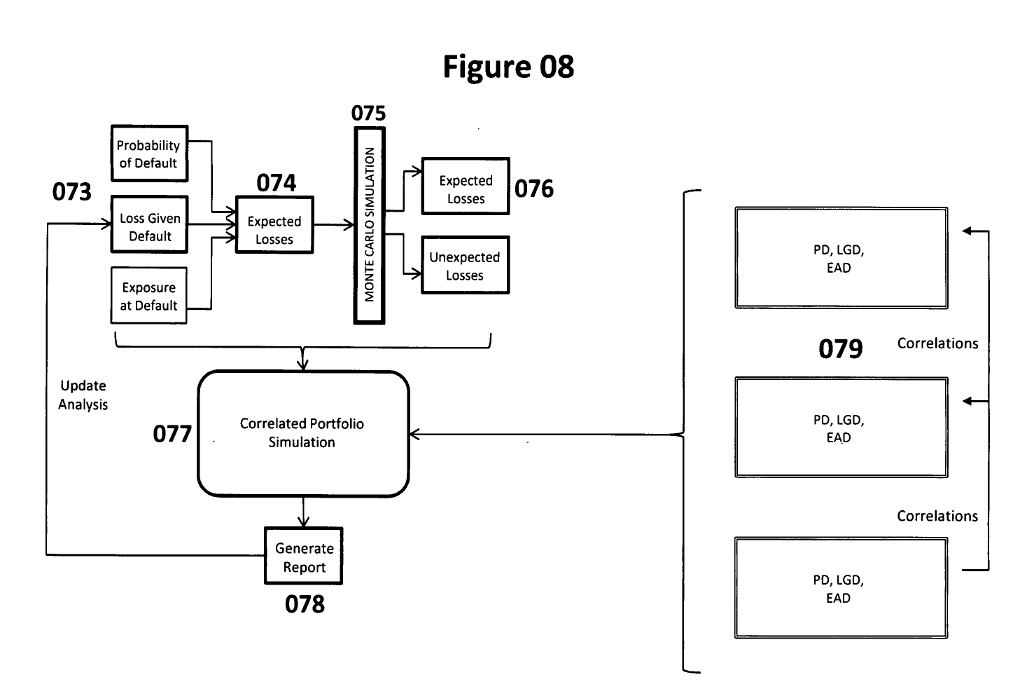

FIG. 08 illustrates how the probability of default, exposure at default, and loss given default 073 are combined into a portfolio of expected losses 074 to compute and simulate 075 the expected and unexpected losses 076 by applying value at risk models. Correlations 077 among the individual groups of credit and debt lines are considered and multiple classes and groups 079 are combined and the portfolio analysis report 078 is generated.

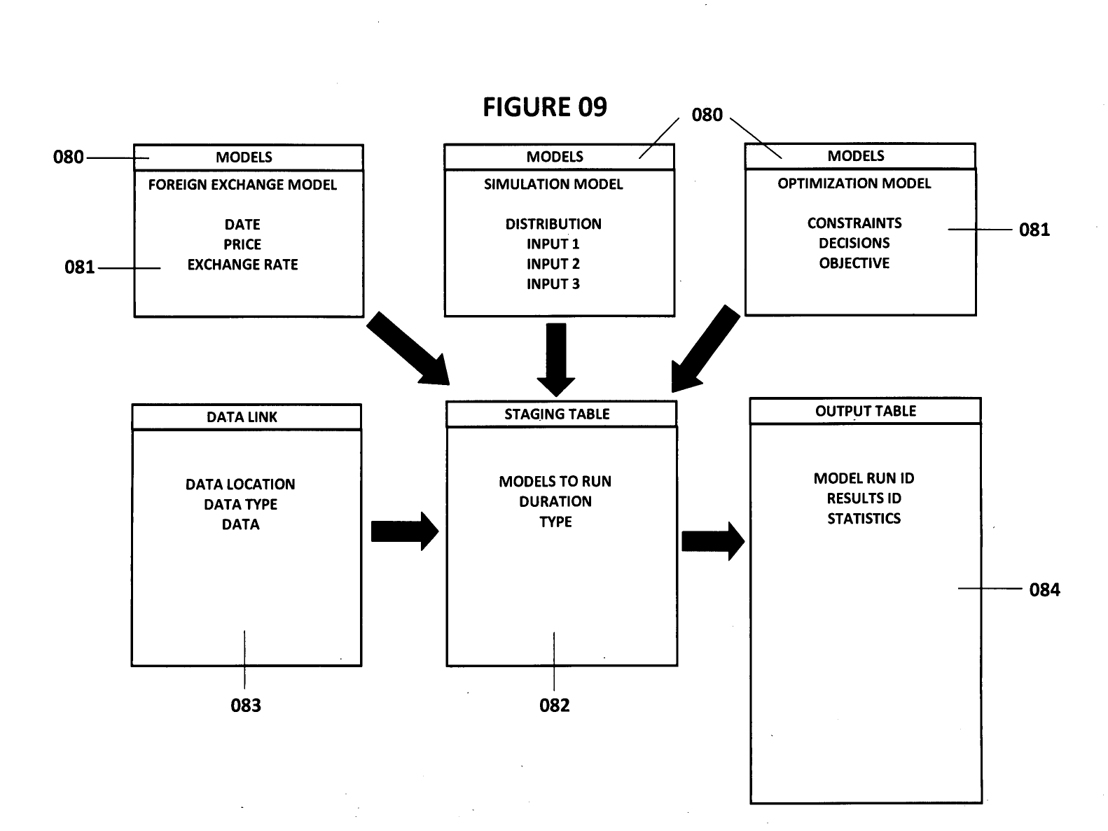

FIG. 09 illustrates the various data table structure 081 underlying the method, when applying the linking procedures when mapping various data bases. The model 080 is central to the model mapping method where the required data tables 082 for each model is created and a report or results tables 083 for each model is created. These are then linked to additional meta-data tables 081 that can be customized and modified as required by the user.

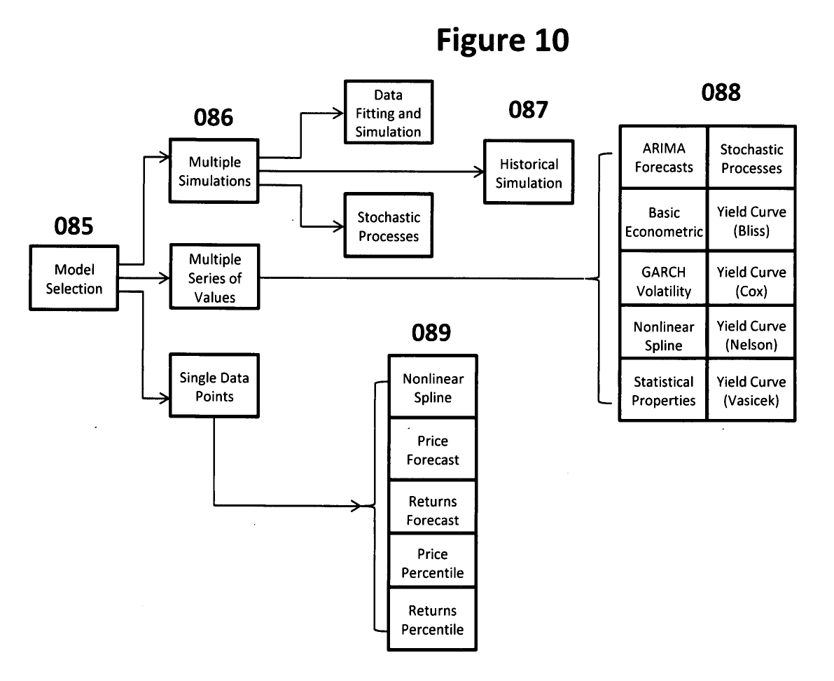

FIG. 10 illustrates the process map for the market risk method, indicating the steps taken by the user in the software. The user first selects the model type 085 in choosing if the required results should be multiple values for a single period, multiple values for multiple periods, or a single data point returned for some period in the future. If multiple values 086 are required, then three methods exist, including data fitting and simulation, historical simulations of existing data, and running the various stochastic processes 087. If multiple values on multiple periods are selected, then ten methods exist including analytics such as ARIMA, econometrics, GARCH and so forth 088. Finally, if single data points are required instead, five different methods are available to the user 089.

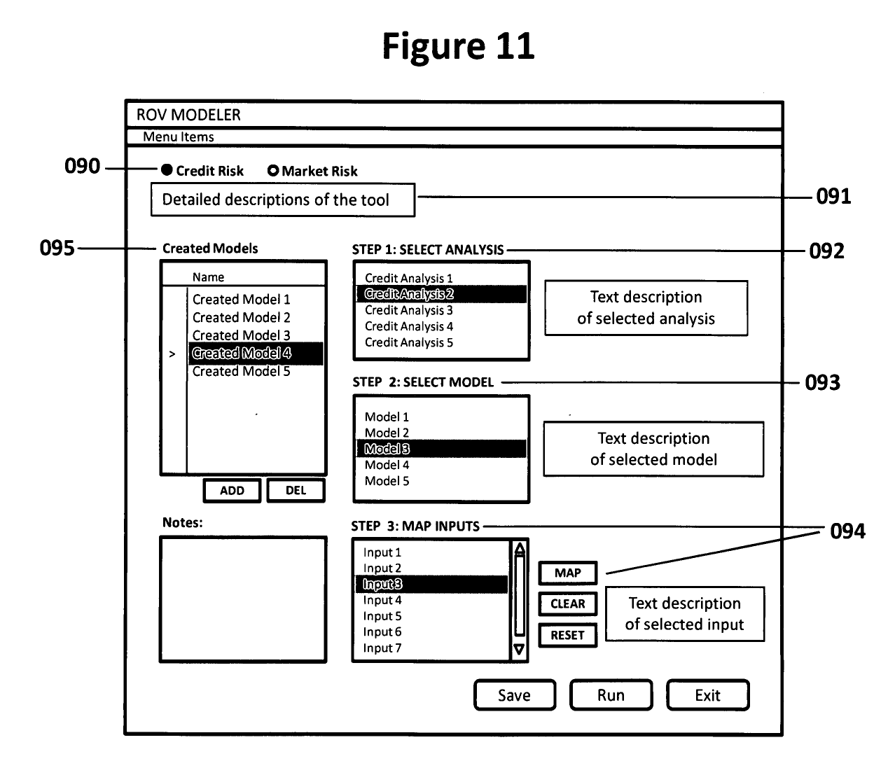

FIG. 11 illustrates the user interface of the present invention, showing the credit risk module 090, where each module and model has detailed descriptions 091 and explanations. The first step is to select the type of analysis to perform 092, and based on the analysis type, a set of models 093 are available and depending on the model chosen, the required input parameters are listed 094 and allow the user to map the required input variable to existing data. Multiple models can be created in the same way and saved in the same profile 095.

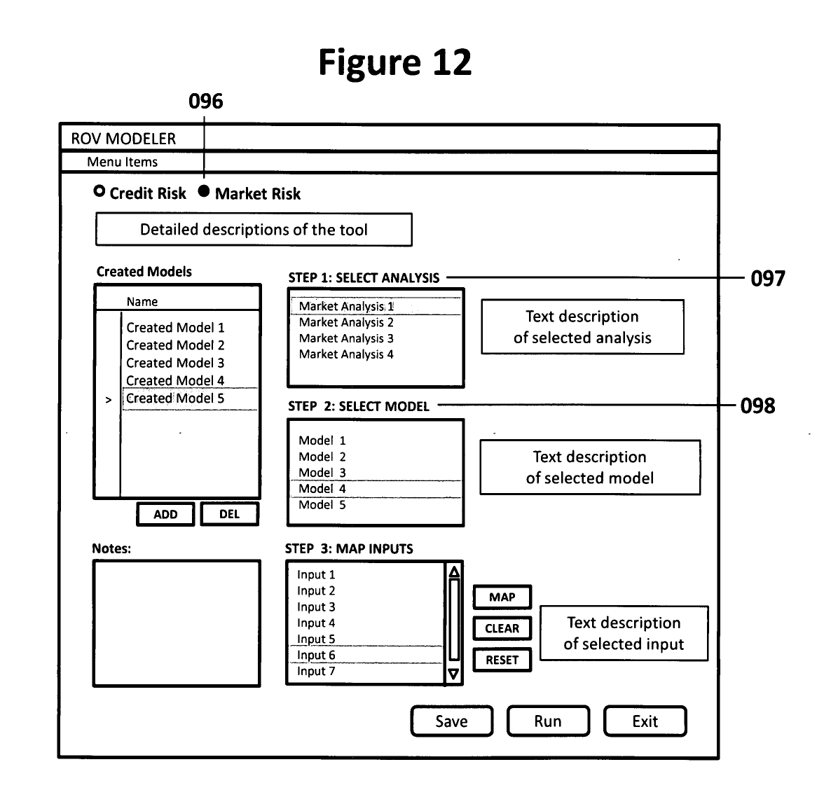

FIG. 12 illustrates the market risk 096 user interface where again, there are different sets of analysis types 097 available, and each type has a set of available models 098 from which to select.

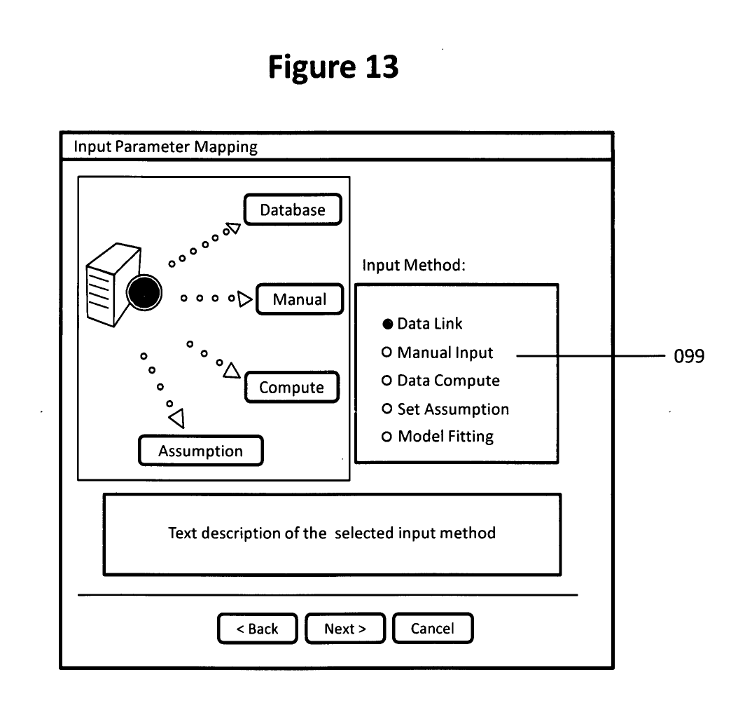

FIG. 13 illustrates how the various input parameters can be mapped to existing data, through five different methods 099: data link (linking to existing data files, databases and other proprietary data sources), manual input (data are types in or pasted in directly), data compute (existing data variables are first modified and analyzed before entering them as input variables), set assumption (creating any of the twenty four statistical distributions to run simulations on) or mode fitting (using existing raw data to find the best-fitting distribution assumption for simulation).

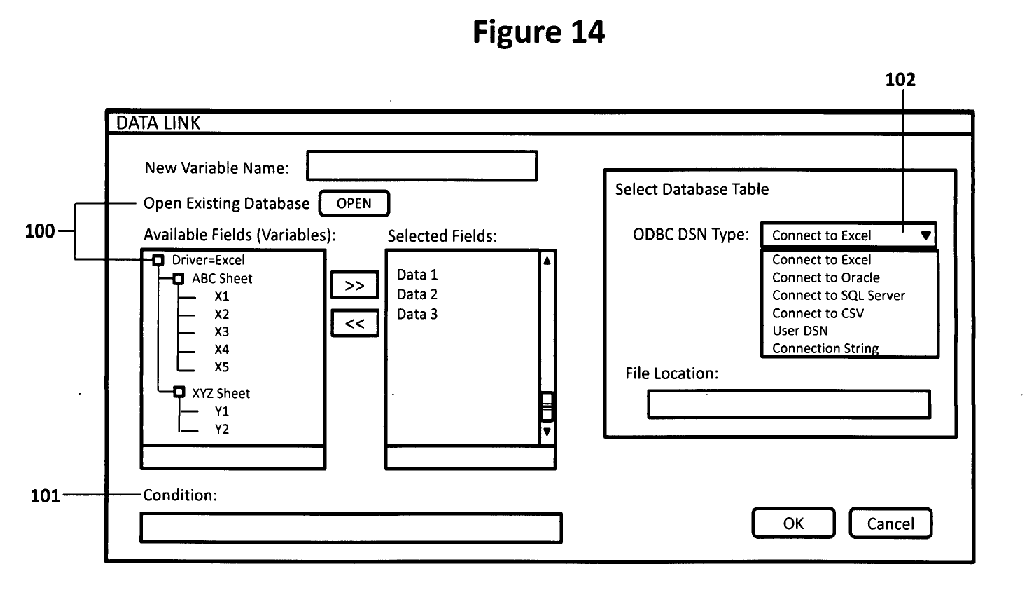

FIG. 14 illustrates the data link process, where an existing database, data file, or data table can be opened 100 to illustrate the available variables, and the data can be filtered using conditional statements 101 and the method links to various databases and data types such as Excel, Oracle financial data model, SQL servers, flat files and other user-specific data files 102.

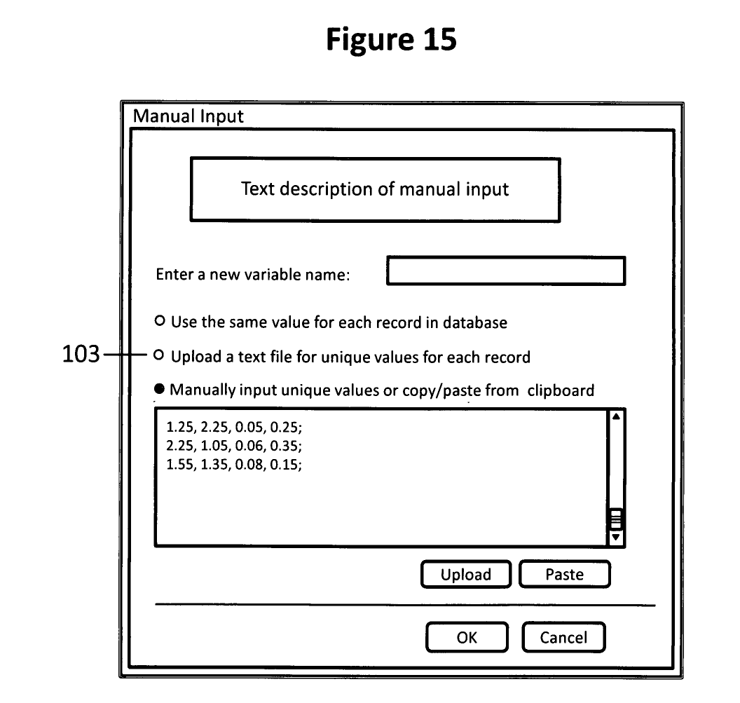

FIG. 15 illustrates the manual input process method where data can be entered in as a matrix, array, or sequence, uploaded from a flat data file, or a single value is replicated for every record in the variable 103.

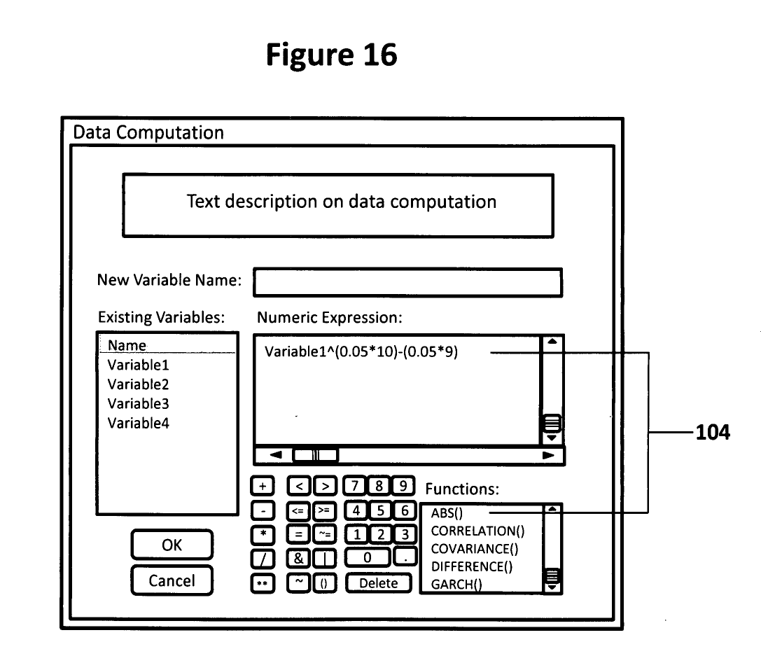

FIG. 16 illustrates the data computation method process where existing variables can be used to compute and generate a new variable 104. This data computation method can parse mathematical functions as illustrated in this figure, including multiple mathematical, statistical and financial functions and applied to numerical inputs typed in directly or using existing data variables.

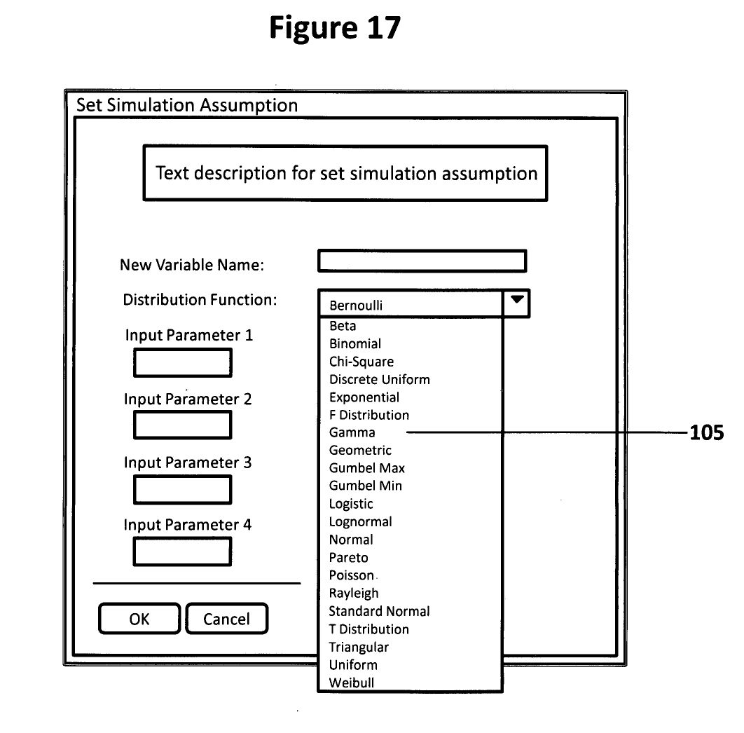

FIG. 17 illustrates the set simulation assumptions method 105, where when no data points exist or when the variable is known to follow some prescribed distribution (e.g., stock prices are lognormal distributed), can be set and a simulation of thousands to millions of values can be generated.

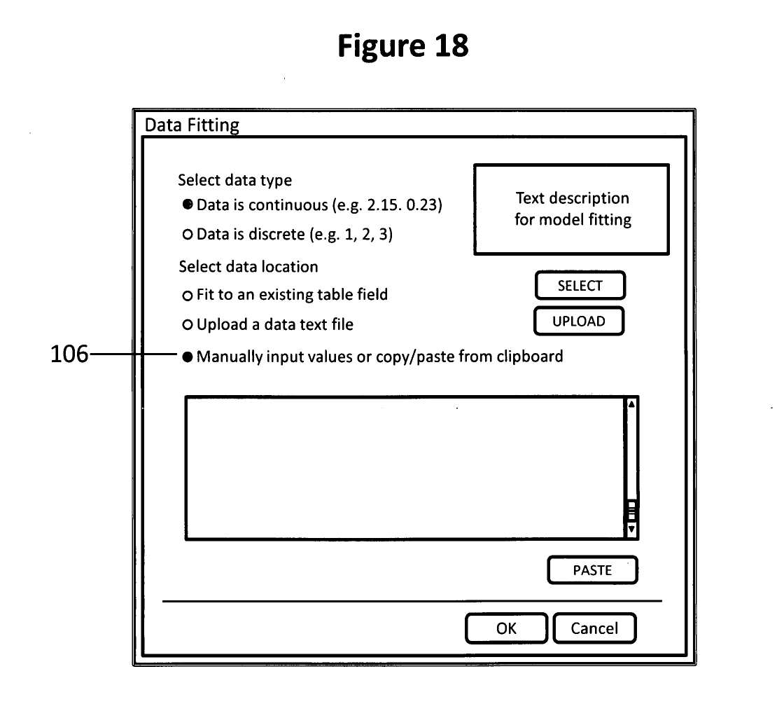

FIG. 18 illustrates the data fitting method 106 where thousands of existing data points can be fitted to a single distributional assumption such that simulations can be run on this variable.

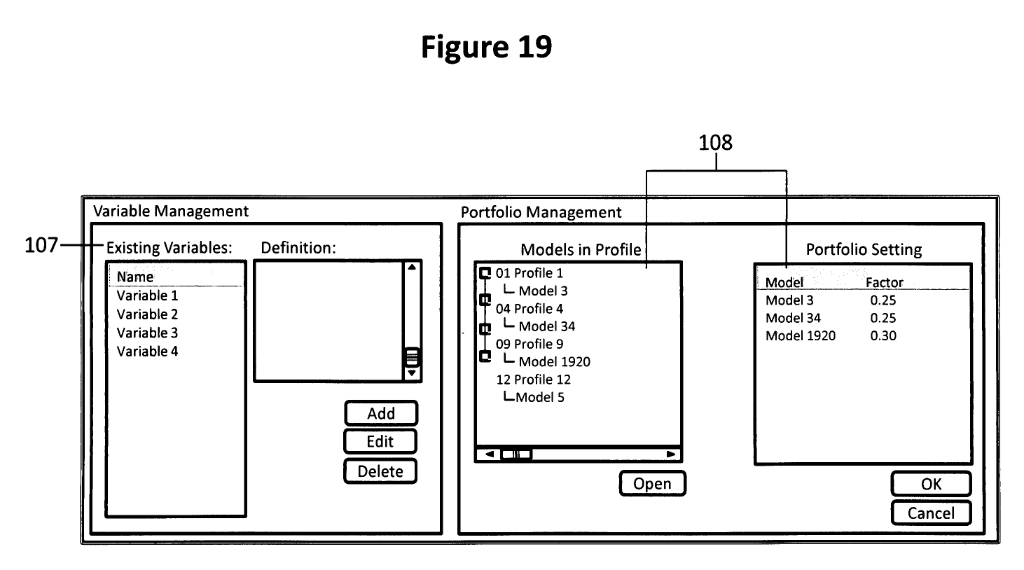

FIG. 19 illustrates the variable management method process where all the required input variables in a specific model are shown and listed in one location 107, and a portfolio management method tool 108 that is capable of opening multiple profiles in a single location such that the entire set of models in various profiles can be run simultaneously within a portfolio environment.

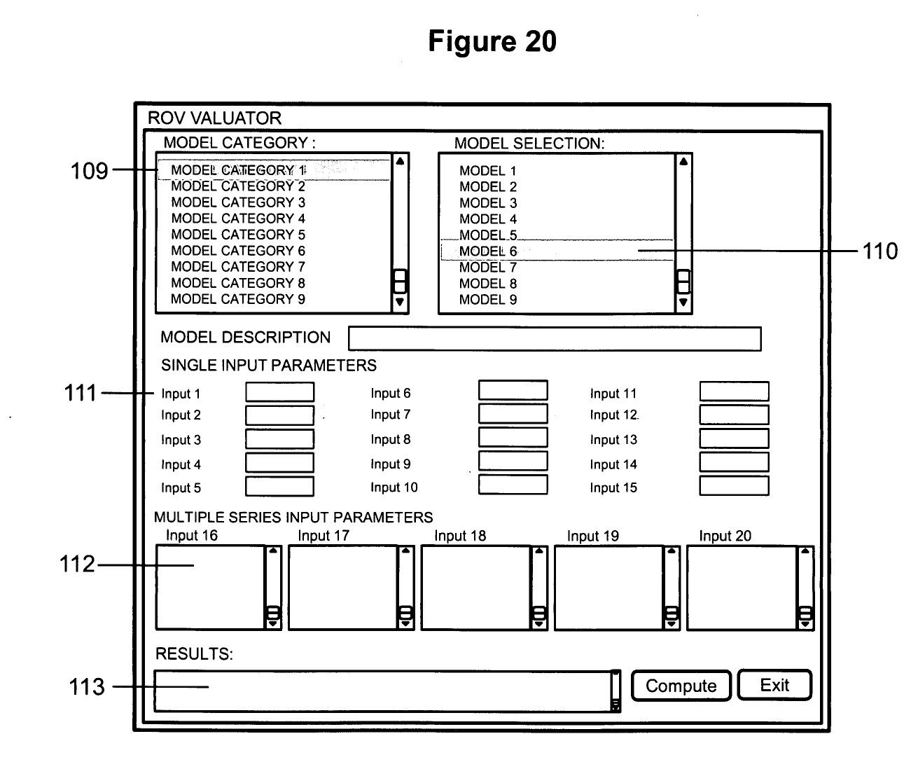

FIG. 20 illustrates the Risk Modeler method. The user will first select a model category 109 to analyze, and depending on the category selected, a list of models 110 is presented and the relevant required input parameters 111 appear. The single point inputs 111 and time-series of data points or matrices or arrays 112 can be entered, and the results are presented 113.

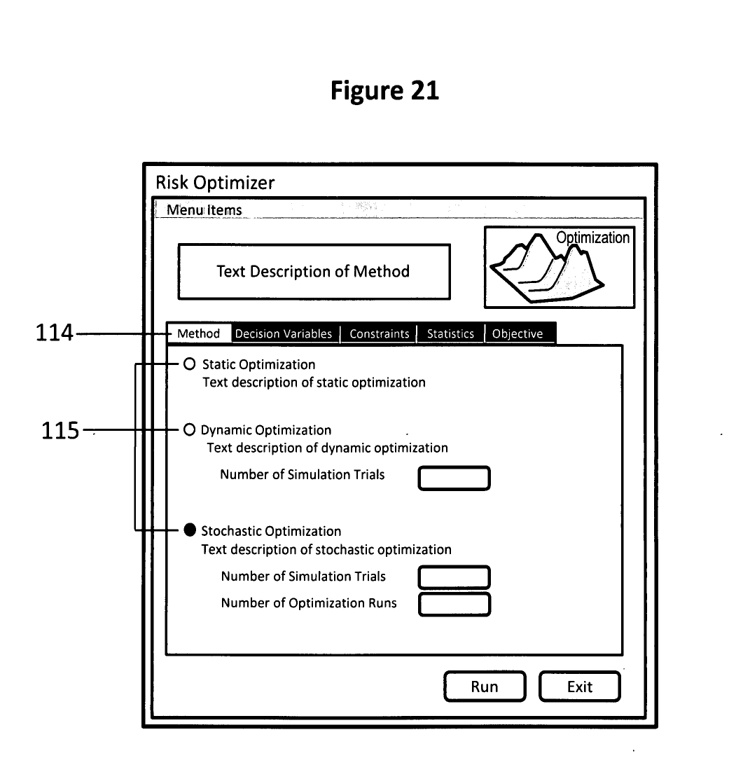

FIG. 21 illustrates the Stochastic Risk Optimizer method, which requires the user to select the method of choice, decision variables, constraints, statistics and objective 114. The method tab illustrates the three optimization techniques available in this method 115. Static optimization runs the optimization routines using static or unchanging values. Dynamic optimization first runs a simulation of thousands of trials and then takes the statistics of the simulation run before running the optimization. Stochastic optimization is similar to dynamic optimization in that it runs dynamic optimization multiple times, generating forecast distributions of decision variables.

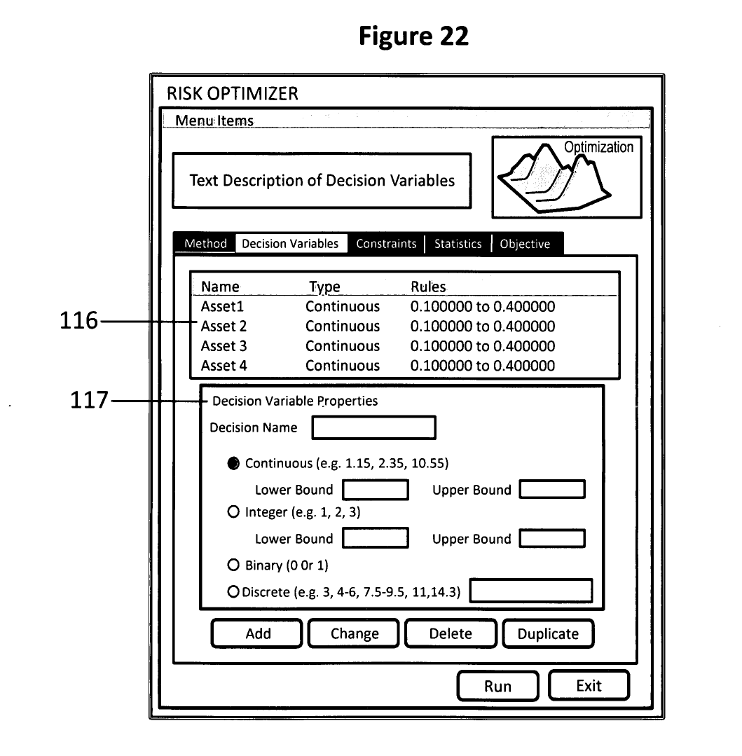

FIG. 22 illustrates the decision variables tab of the Stochastic Risk Optimizer method where decision variables 116 can be entered as continuous variables (e.g., 1.15, 2.35 and so forth), integers (e.g., 1, 2, 3), binary (0 or 1) or specific discrete values 117.

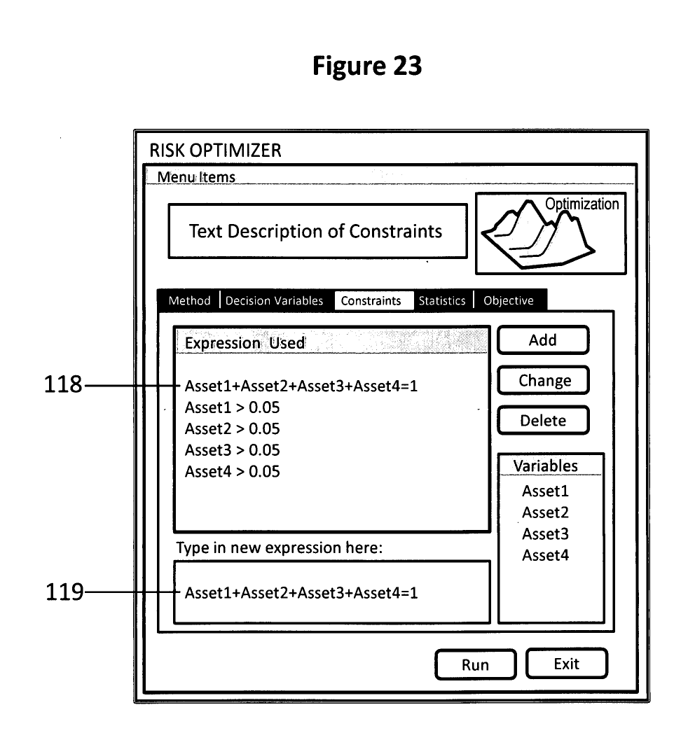

FIG. 23 illustrates the constraints tab of the optimizer method 118 where the constraints can be entered using the existing variables in the model 119. Multiple constraints can be entered in this method.

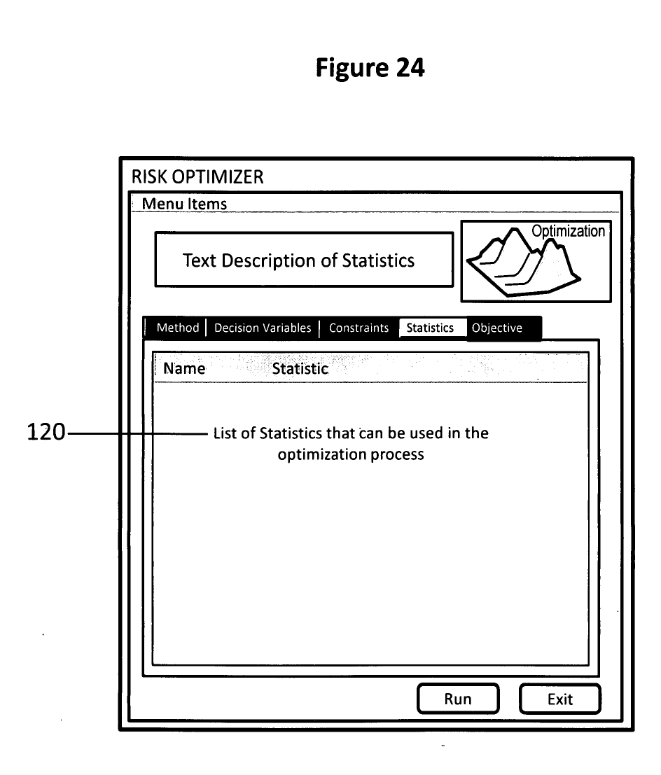

FIG. 24 illustrates the statistics tab 120 of the optimizer method, where various statistics from a simulation run can be used and replaced in the optimization method.

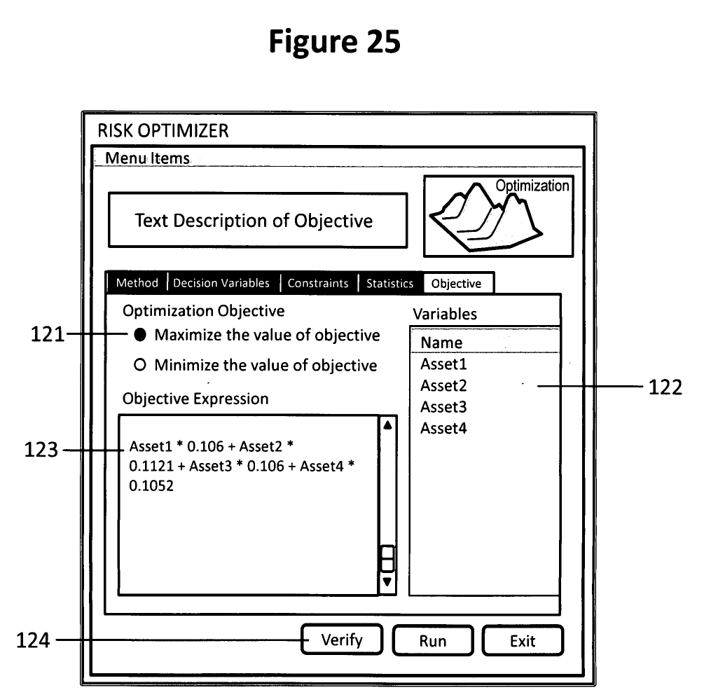

FIG. 25 illustrates the optimization method's objective function 123 based on available variables 122 that can be entered manually to be maximized or minimized 121. The method also allows the user to verify the model setup 124 as a process check before running the optimization method.

### Credit and Market Risks

This section demonstrates the mathematical models and computations used in creating the results for credit and market risks in this present invention.

An approach that is used in the computation of market risks is the use of stochastic process simulation, which is a mathematically defined equation that can create a series of outcomes over time, outcomes that are not deterministic in nature. That is, an equation or process that does not follow any simple discernible rule such as price will increase X percent every year or revenues will increase by this factor of X plus Y percent. A stochastic process is by definition nondeterministic, and one can plug numbers into a stochastic process equation and obtain different results every time. For instance, the path of a stock price is stochastic in nature, and one cannot reliably predict the stock price path with any certainty. However, the price evolution over time is enveloped in a process that generates these prices. The process is fixed and predetermined, but the outcomes are not. Hence, by stochastic simulation, we create multiple pathways of prices, obtain a statistical sampling of these simulations, and make inferences on the potential pathways that the actual price may undertake given the nature and parameters of the stochastic process used to generate the time-series.

Four basic stochastic processes are discussed, including the Geometric Brownian Motion, which is the most common and prevalently used process due to its simplicity and wide-ranging applications. The mean-reversion process, barrier long-run process, and jump-diffusion process are also briefly discussed.

### Summary Mathematical Characteristics of Geometric Brownian Motions

Assume a process X, where X=[Xₜ:t≧0] if and only if Xₜ is continuous, where the starting point is X₀=0, where X is normally distributed with mean zero and variance one or X ε N(0, 1), and where each increment in time is independent of each other previous increment and is itself normally distributed with mean zero and variance t, such that Xₜ₊ₐ−Xₜ ε N(0, t). Then, the process dX=α X dt+δ X dZ follows a Geometric Brownian Motion, where α is a drift parameter, δ the volatility measure, dZ=εₜ\sqrt{Δdt} such that 1 n

$$[ \frac{dX}{X} ] ∈ N ( μ , σ )$$

or X and dX are lognormally distributed. If at time zero, X(0)=0 then the expected value of the process X at any time t is such that E[X(t)]=X₀e^{αt} and the variance of the process X at time t is V[X(t)]=X₀²e^{2αt}(e^{δ}^{²}^{t}−1). In the continuous case where there is a drift parameter α, the expected value then becomes

$$E [ {\int }_{0}^{∞} X ( t ) {e}^{- rt} d t ] = {\int }_{0}^{∞} {X}_{0} {e}^{- ( r - α ) t} d t = \frac{{X}_{0}}{( r - α )} .$$

### Summary Mathematical Characteristics of Mean-Reversion Processes

If a stochastic process has a long-run attractor such as a long-run production cost or long-run steady state inflationary price level, then a mean-reversion process is more likely. The process reverts to a long-run average such that the expected value is E[Xₜ]= X̅+(X₀− X̅)e^{-ηt} and the variance is

$$V [ {X}_{t} - \overline{X} ] = \frac{{σ}^{2}}{2 η ( 1 - {e}^{- 2 η t} )} .$$

The special circumstance that becomes useful is that in the limiting case when the time change becomes instantaneous or when dt→0, we have the condition where Xₜ−Xₜ₋₁= X̅(1−e^{-η})+Xₜ₋₁(e^{-η}−1)+εₜ which is the first order autoregressive process, and η can be tested econometrically in a unit root context.

### Summary Mathematical Characteristics of Barrier Long-Run Processes

This process is used when there are natural barriers to prices—for example, like floors or caps—or when there are physical constraints like the maximum capacity of a manufacturing plant. If barriers exist in the process, where we define X̅ as the upper barrier and X as the lower barrier, we have a process where

$$X ( t ) = \frac{2 α}{{σ}^{2}} \frac{{e}^{\frac{2 α X}{{σ}^{2}}}}{{e}^{\frac{2 α \overline{X}}{{σ}^{2}}} - {e}^{\frac{2 α \underline{X}}{{σ}^{2}}}} .$$

### Summary Mathematical Characteristics of Jump-Diffusion Processes

Start-up ventures and research and development initiatives usually follow a jump-diffusion process. Business operations may be status quo for a few months or years, and then a product or initiative becomes highly successful and takes off. An initial public offering of equities, oil price jumps, and price of electricity are textbook examples of this. Assuming that the probability of the jumps follows a Poisson distribution, we have a process dX=f(X, t)dt+g(X, t)dq, where the functions f and g are known and where the probability process is

$$d q = \{ \begin{matrix}0 & with P ( X ) = 1 - λ d t \\ μ & with P ( X ) - X d t .\end{matrix}$$

For credit risk methods, several of the models are proprietary in nature whereas the key models and approaches are illustrated below. The Maximum Likelihood Estimates (MLE) approach on a binary multivariate logistic analysis is used to model dependent variables to determine the expected probability of success of belonging to a certain group. For instance, given a set of independent variables (e.g., age, income, education level of credit card or mortgage loan holders), we can model the probability of default using MLE. A typical regression model is invalid because the errors are heteroskedastic and nonnormal, and the resulting estimated probability estimates will sometimes be above 1 or below 0. MLE analysis handles these problems using an iterative optimization routine. The computed results show the coefficients of the estimated MLE intercept and slopes.

For instance, the coefficients are estimates of the true population b values in the following equation Y=β₀+β₁X₁+β₂X₂+ . . . +βₙXₙ. The standard error measures how accurate the predicted coefficients are, and the Z-statistics are the ratios of each predicted coefficient to its standard error. The Z-statistic is used in hypothesis testing, where we set the null hypothesis (Ho) such that the real mean of the coefficient is equal to zero, and the alternate hypothesis (Ha) such that the real mean of the coefficient is not equal to zero. The Z-test is very important as it calculates if each of the coefficients is statistically significant in the presence of the other regressors. This means that the Z-test statistically verifies whether a regressor or independent variable should remain in the model or it should be dropped. That is, the smaller the p-value, the more significant the coefficient. The usual significant levels for the p-value are 0.01, 0.05, and 0.10, corresponding to the 99%, 95%, and 99% confidence levels.

The coefficients estimated are actually the logarithmic odds ratios, and cannot be interpreted directly as probabilities. A quick but simple computation is first required. The approach is simple. To estimate the probability of success of belonging to a certain group (e.g., predicting if a debt holder will default given the amount of debt he holds), simply compute the estimated Y value using the MLE coefficients. To illustrate, an individual with 8 years at a current employer and current address, a low 3% debt to income ratio and $2,000 in credit card debt has a log odds ratio of −3.1549. The inverse antilog of the odds ratio is obtained by computing:

$$\frac{exp ( \text{estimated} Y )}{1 + exp ( \text{estimated} Y )} = \frac{exp ( - 3.1549 )}{1 + exp ( - 3.1549 )} = 0.0409$$

### GARCH Approach

The GARCH (Generalized Autoregressive Conditional Heteroskedasticity) modeling approach can be utilized to estimate the volatility of any time-series data. GARCH models are used mainly in analyzing financial time-series data, in order to ascertain their conditional variances and volatilities. These volatilities are then used to value the options as usual, but the amount of historical data necessary for a good volatility estimate remains significant. Usually, several dozens—and even up to hundreds—of data points are required to obtain good GARCH estimates. In addition, GARCH models are very difficult to run and interpret and require great facility with econometric modeling techniques. GARCH is a term that incorporates a family of models that can take on a variety of forms, known as GARCH(p,q), where p and q are positive integers that define the resulting GARCH model and its forecasts.

For instance, a GARCH (1,1) model takes the form of

yₜ=xₜγ+εₜ

σₜ²=ω+αεₜ₋₁²+βδₜ₋₁²

where the first equation's dependent variable (yₜ) is a function of exogenous variables (xₜ) with an error term (εₜ). The second equation estimates the variance (squared volatility σₜ²) at time t, which depends on a historical mean (ω), news about volatility from the previous period, measured as a lag of the squared residual from the mean equation (εₜ₋₁²), and volatility from the previous period (σₜ₋₁²). Detailed knowledge of econometric modeling (model specification tests, structural breaks, and error estimation) is required to run a GARCH model, making it less accessible to the general analyst. The other problem with GARCH models is that the model usually does not provide a good statistical fit. That is, it is impossible to predict the stock market, and of course equally if not harder, to predict a stock's volatility over time.

### Mathematical Probability Distributions

This section demonstrates the mathematical models and computations used in creating the Monte Carlo simulations. In order to get started with simulation, one first needs to understand the concept of probability distributions. To begin to understand probability, consider this example: You want to look at the distribution of nonexempt wages within one department of a large company. First, you gather raw data—in this case, the wages of each nonexempt employee in the department. Second, you organize the data into a meaningful format and plot the data as a frequency distribution on a chart. To create a frequency distribution, you divide the wages into group intervals and list these intervals on the chart's horizontal axis. Then you list the number or frequency of employees in each interval on the chart's vertical axis. Now you can easily see the distribution of nonexempt wages within the department. You can chart this data as a probability distribution. A probability distribution shows the number of employees in each interval as a fraction of the total number of employees. To create a probability distribution, you divide the number of employees in each interval by the total number of employees and list the results on the chart's vertical axis.

Probability distributions are either discrete or continuous. Discrete probability distributions describe distinct values, usually integers, with no intermediate values and are shown as a series of vertical bars. A discrete distribution, for example, might describe the number of heads in four flips of a coin as 0, 1, 2, 3, or 4. Continuous probability distributions are actually mathematical abstractions because they assume the existence of every possible intermediate value between two numbers; that is, a continuous distribution assumes there is an infinite number of values between any two points in the distribution. However, in many situations, you can effectively use a continuous distribution to approximate a discrete distribution even though the continuous model does not necessarily describe the situation exactly.

### Probability Density Functions, Cumulative Distribution Functions, and Probability Mass Functions

In mathematics and Monte Carlo simulation, a probability density function (PDF) represents a continuous probability distribution in terms of integrals. If a probability distribution has a density of f(x), then intuitively the infinitesimal interval of [x, x+dx] has a probability of f(x) dx. The PDF therefore can be seen as a smoothed version of a probability histogram; that is, by providing an empirically large sample of a continuous random variable repeatedly, the histogram using very narrow ranges will resemble the random variable's PDF. The probability of the interval between [a, b] is given by

$${\int }_{a}^{b} f ( x ) d x ,$$

which means that the total integral of the function f must be 1.0. It is a common mistake to think of f(a) as the probability of a. This is incorrect. In fact, f(a) can sometimes be larger than 1—consider a uniform distribution between 0.0 and 0.5. The random variable x within this distribution will have f(x) greater than 1. The probability in reality is the function f(x)dx discussed previously, where dx is an infinitesimal amount.

The cumulative distribution function (CDF) is denoted as F(x)=P(X≦x) indicating the probability of X taking on a less than or equal value to x. Every CDF is monotonically increasing, is continuous from the right, and at the limits, have the following properties:

$${lim}_{x -> - ∞} F ( x ) = 0 \text{and} {lim}_{x -> + ∞} F ( x ) = 1.$$

Further, the CDF is related to the PDF by

$$F ( b ) - F ( a ) = P ( a \leq X \leq b ) = {\int }_{a}^{b} f ( x ) d x ,$$

where the PDF function f is the derivative of the CDF function F.

In probability theory, a probability mass function or PMF gives the probability that a discrete random variable is exactly equal to some value. The PMF differs from the PDF in that the values of the latter, defined only for continuous random variables, are not probabilities; rather, its integral over a set of possible values of the random variable is a probability. A random variable is discrete if its probability distribution is discrete and can be characterized by a PMF. Therefore, X is a discrete random variable if

$${\sum }_{u} P ( X = u ) = 1$$

as u runs through all possible values of the random variable X.

### Discrete Distributions

Following is a detailed listing of the different types of probability distributions that can be used in Monte Carlo simulation.

### Bernoulli or Yes/No Distribution

The Bernoulli distribution is a discrete distribution with two outcomes (e.g., head or tails, success or failure, 0 or 1). The Bernoulli distribution is the binomial distribution with one trial and can be used to simulate Yes/No or Success/Failure conditions. This distribution is the fundamental building block of other more complex distributions. For instance:
Binomial distribution: Bernoulli distribution with higher number of n total trials and computes the probability of x successes within this total number of trials.
Geometric distribution: Bernoulli distribution with higher number of trials and computes the number of failures required before the first success occurs.
Negative binomial distribution: Bernoulli distribution with higher number of trials and computes the number of failures before the xth success occurs.

The mathematical constructs for the Bernoulli distribution are as follows:

$$P ( x ) = \{ \begin{matrix}1 - p & for x = 0 \\ p & for x = 1\end{matrix} \\ \text{or} \\ P ( x ) = {{p}^{x} ( 1 - p )}^{1 - x} \\ mean = p \\ standard deviation = \sqrt{p ( 1 - p )} \\ skewness = \frac{1 - 2 p}{\sqrt{p ( 1 - p )}} \\ excess kurtosis = \frac{6 {p}^{2} - 6 p + 1}{p ( 1 - p )}$$

The probability of success (p) is the only distributional parameter. Also, it is important to note that there is only one trial in the Bernoulli distribution, and the resulting simulated value is either 0 or 1. The input requirements are such that

Probability of Success>0 and <1 (that is, 0.0001≦p≦0.9999).

### Binomial Distribution

The binomial distribution describes the number of times a particular event occurs in a fixed number of trials, such as the number of heads in 10 flips of a coin or the number of defective items out of 50 items chosen.

The three conditions underlying the binomial distribution are:
For each trial, only two outcomes are possible that are mutually exclusive.
The trials are independent—what happens in the first trial does not affect the next trial.
The probability of an event occurring remains the same from trial to trial.

The mathematical constructs for the binomial distribution are as follows:

$$P ( x ) = \frac{n !}{x ! ( n - x ) !} {{p}^{x} ( 1 - p )}^{( n - x )}$$

$$for n > 0 ; x = 0 , 1 , 2 , … n ; and 0 < p < 1$$

$$mean = np$$

$$standard deviation = \sqrt{np ( 1 - p )}$$

$$skewness = \frac{1 - 2 p}{\sqrt{np ( 1 - p )}}$$

$$excess kurtosis = \frac{6 {p}^{2} - 6 p + 1}{np ( 1 - p )}$$

The probability of success (p) and the integer number of total trials (n) are the distributional parameters. The number of successful trials is denoted x. It is important to note that probability of success (p) of 0 or 1 are trivial conditions and do not require any simulations, and hence, are not allowed in the software. The input requirements are such that Probability of Success>0 and <1 (that is, 0.0001≦p≦0.9999), the Number of Trials≧1 or positive integers and ≦1000 (for larger trials, use the normal distribution with the relevant computed binomial mean and standard deviation as the normal distribution's parameters).

### Discrete Uniform

The discrete uniform distribution is also known as the equally likely outcomes distribution, where the distribution has a set of N elements, and each element has the same probability. This distribution is related to the uniform distribution but its elements are discrete and not continuous. The mathematical constructs for the discrete uniform distribution are as follows:

$$P ( x ) = \frac{1}{N}$$

$$mean = \frac{N + 1}{2} ranked value$$

$$standard deviation = \sqrt{\frac{( N - 1 ) ( N + 1 )}{12}} ranked value$$

$$skewness = 0 \text{(that is, the distribution is perfectly symmetrical)}$$

$$excess kurtosis = \frac{- 6 ( {N}^{2} + 1 )}{5 ( N - 1 ) ( N + 1 )} ranked value$$

The input requirements are such that Minimum<Maximum and both must be integers (negative integers and zero are allowed).

### Geometric Distribution

The geometric distribution describes the number of trials until the first successful occurrence, such as the number of times you need to spin a roulette wheel before you win.

The three conditions underlying the geometric distribution are:
The number of trials is not fixed.
The trials continue until the first success.
The probability of success is the same from trial to trial.

The mathematical constructs for the geometric distribution are as follows:

$$P ( x ) = {p ( 1 - p )}^{x - 1} for 0 < p < 1 and x = 1 , 2 , … , n$$

$$mean = \frac{1}{p} - 1$$

$$standard deviation = \sqrt{\frac{1 - p}{{p}^{2}}} \\ skewness = \frac{2 - p}{\sqrt{1 - p}} \\ excess kurtosis = \frac{{p}^{2} - 6 p + 6}{1 - p}$$

The probability of success (p) is the only distributional parameter. The number of successful trials simulated is denoted x, which can only take on positive integers. The input requirements are such that Probability of success >0 and <1 (that is, 0.0001≦p≦0.9999). It is important to note that probability of success (p) of 0 or 1 are trivial conditions and do not require any simulations, and hence, are not allowed in the software.

### Hypergeometric Distribution

The hypergeometric distribution is similar to the binomial distribution in that both describe the number of times a particular event occurs in a fixed number of trials. The difference is that binomial distribution trials are independent, whereas hypergeometric distribution trials change the probability for each subsequent trial and are called trials without replacement. For example, suppose a box of manufactured parts is known to contain some defective parts. You choose a part from the box, find it is defective, and remove the part from the box. If you choose another part from the box, the probability that it is defective is somewhat lower than for the first part because you have removed a defective part. If you had replaced the defective part, the probabilities would have remained the same, and the process would have satisfied the conditions for a binomial distribution.

The three conditions underlying the hypergeometric distribution are:
The total number of items or elements (the population size) is a fixed number, a finite population. The population size must be less than or equal to 1,750.
The sample size (the number of trials) represents a portion of the population.
The known initial probability of success in the population changes after each trial.

The mathematical constructs for the hypergeometric distribution are as follows:

$$P ( x ) = \frac{\frac{( {N}_{x} ) !}{x ! ( {N}_{x} - x ) !} \frac{( N - {N}_{x} ) !}{( n - x ) ! ( N - {N}_{x} - n + x ) !}}{\frac{N !}{n ! ( N - n ) !}}$$

$$for x = Max ( n - ( N - {N}_{x} ) , 0 ) , … , Min ( n , {N}_{x} )$$

$$mean = \frac{{N}_{x} n}{N}$$

$$standard deviation = \sqrt{\frac{( N - {N}_{x} ) {N}_{x} n ( N - n )}{{N}^{2} ( N - 1 )}}$$

$$skewness = \frac{( N - 2 {N}_{x} ) ( N - 2 n )}{N - 2} \sqrt{\frac{N - 1}{( N - {N}_{x} ) {N}_{x} n ( N - n )}}$$

$$excess kurtosis = \frac{V ( N , {N}_{x} , n )}{( N - {N}_{x} ) {N}_{x} n ( - 3 + N ) ( - 2 + N ) ( - N + n )}$$

$$\text{where}$$

$$V ( N , {N}_{x} , n ) = {( N - {N}_{x} )}^{3} - {( N - {N}_{x} )}^{5} + 3 {( N - {N}_{x} )}^{2} {N}_{x} - 6 {( N - {N}_{x} )}^{3} {N}_{x} + {( N - {N}_{x} )}^{4} {N}_{x} + 3 ( N - {N}_{x} ) {N}_{x}^{2} - 12 {( N - {N}_{x} )}^{2} {N}_{x}^{2} + 8 {( N - {N}_{x} )}^{3} {N}_{x}^{2} + {N}_{x}^{3} - 6 ( N - {N}_{x} ) {N}_{x}^{3} + 8 {( N - {N}_{x} )}^{2} {N}_{x}^{3} + ( N - {N}_{x} ) {N}_{x}^{4} - {N}_{x}^{5} - 6 {( N - {N}_{x} )}^{3} {N}_{x} + 6 {( N - {N}_{x} )}^{4} {N}_{x} + 18 {( N - {N}_{x} )}^{2} {N}_{x} n - 6 {( N - {N}_{x} )}^{3} {N}_{x} n + 18 ( N - {N}_{x} ) {N}_{x}^{2} n - 24 {( N - {N}_{x} )}^{2} {N}_{x}^{2} n - 6 {( N - {N}_{x} )}^{3} n - 6 ( N - {N}_{x} ) {N}_{x}^{3} n + 6 {N}_{x}^{4} n + 6 {( N - {N}_{x} )}^{2} {n}^{2} - 6 {( N - {N}_{x} )}^{3} {n}^{2} - 24 ( N - {N}_{x} ) {N}_{x} {n}^{2} + 12 {( N - {N}_{x} )}^{2} {N}_{x} {n}^{2} + 6 {N}_{x}^{2} {n}^{2} + 12 ( N - {N}_{x} ) {N}_{x}^{2} {n}^{2} - 6 {N}_{x}^{3} {n}^{2}$$

The number of items in the population (N), trials sampled (n), and number of items in the population that have the successful trait (Nₓ) are the distributional parameters. The number of successful trials is denoted x. The input requirements are such that Population ≧2 and integer,

Trials>0 and integer

Successes>0 and integer, Population>Successes

Trials<Population and Population<1750.

### Negative Binomial Distribution

The negative binomial distribution is useful for modeling the distribution of the number of trials until the rth successful occurrence, such as the number of sales calls you need to make to close a total of 10 orders. It is essentially a superdistribution of the geometric distribution. This distribution shows the probabilities of each number of trials in excess of r to produce the required success r.

### Conditions

The three conditions underlying the negative binomial distribution are:
The number of trials is not fixed.
The trials continue until the rth success.
The probability of success is the same from trial to trial.

The mathematical constructs for the negative binomial distribution are as follows:

$$P ( x ) = \frac{( x + r - 1 ) !}{( r - 1 ) ! x !} {{p}^{r} ( 1 - p )}^{x}$$

$$for x = r , r + 1 , … ; and 0 < p < 1$$

$$mean = \frac{r ( 1 - p )}{p}$$

$$standard deviation = \sqrt{\frac{r ( 1 - p )}{{p}^{2}}}$$

$$skewness = \frac{2 - p}{\sqrt{r ( 1 - p )}} \\ excess kurtosis = \frac{{p}^{2} - 6 p + 6}{r ( 1 - p )}$$

Probability of success (p) and required successes (r) are the distributional parameters. Where the input requirements are such that Successes required must be positive integers >0 and <8000, Probability of success >0 and <1 (that is, 0.0001≦p≦0.9999). It is important to note that probability of success (p) of 0 or 1 are trivial conditions and do not require any simulations, and hence, are not allowed in the software.

### Poisson Distribution

The Poisson distribution describes the number of times an event occurs in a given interval, such as the number of telephone calls per minute or the number of errors per page in a document.

### Conditions

The three conditions underlying the Poisson distribution are:
The number of possible occurrences in any interval is unlimited.
The occurrences are independent. The number of occurrences in one interval does not affect the number of occurrences in other intervals.
The average number of occurrences must remain the same from interval to interval.

The mathematical constructs for the Poisson are as follows:

$$P ( x ) = \frac{{e}^{- λ} {λ}^{x}}{x !} for x and λ > 0$$

$$mean = λ$$

$$standard deviation = \sqrt{λ}$$

$$skewness = \frac{1}{\sqrt{λ}} \\ excess kurtosis = \frac{1}{λ}$$

Rate (λ) is the only distributional parameter and the input requirements are such that Rate>0 and ≦1000 (that is, 0.0001≦rate ≦1000).

### Continuous Distributions

### Beta Distribution

The beta distribution is very flexible and is commonly used to represent variability over a fixed range. One of the more important applications of the beta distribution is its use as a conjugate distribution for the parameter of a Bernoulli distribution. In this application, the beta distribution is used to represent the uncertainty in the probability of occurrence of an event. It is also used to describe empirical data and predict the random behavior of percentages and fractions, as the range of outcomes is typically between 0 and 1. The value of the beta distribution lies in the wide variety of shapes it can assume when you vary the two parameters, alpha and beta. If the parameters are equal, the distribution is symmetrical. If either parameter is 1 and the other parameter is greater than 1, the distribution is J-shaped. If alpha is less than beta, the distribution is said to be positively skewed (most of the values are near the minimum value). If alpha is greater than beta, the distribution is negatively skewed (most of the values are near the maximum value). The mathematical constructs for the beta distribution are as follows:

$$f ( x ) = \frac{{( x )}^{( α - 1 )} {( 1 - x )}^{( β - 1 )}}{[ \frac{Γ ( α ) Γ ( β )}{Γ ( α + β )} ]} for α > 0 ; β > 0 ; x > 0$$

$$mean = \frac{α}{α + β}$$

$$standard deviation = \sqrt{\frac{αβ}{{( α + β )}^{2} ( 1 + α + β )}}$$

$$skewness = \frac{2 ( β - α ) \sqrt{1 + α + β}}{( 2 + α + β ) \sqrt{αβ}} \\ excess kurtosis = \frac{3 ( α + β + 1 ) [ αβ ( α + β - 6 ) + 2 {( α + β )}^{2} ]}{αβ ( α + β + 2 ) ( α + β + 3 )} - 3$$

Alpha (α) and beta (β) are the two distributional shape parameters, and Γ is the gamma function.

The two conditions underlying the beta distribution are:
The uncertain variable is a random value between 0 and a positive value.
The shape of the distribution can be specified using two positive values. Input requirements:

Alpha and beta>0 and can be any positive value

### Cauchy Distribution or Lorentzian Distribution or Breit-Wigner Distribution

The Cauchy distribution, also called the Lorentzian distribution or Breit-Wigner distribution, is a continuous distribution describing resonance behavior. It also describes the distribution of horizontal distances at which a line segment tilted at a random angle cuts the x-axis.

The mathematical constructs for the cauchy or Lorentzian distribution are as follows:

$$f ( x ) = \frac{1}{π} \frac{γ / 2}{{( x - m )}^{2} + {γ}^{2} / 4}$$

The cauchy distribution is a special case where it does not have any theoretical moments (mean, standard deviation, skewness, and kurtosis) as they are all undefined. Mode location (m) and scale (γ) are the only two parameters in this distribution. The location parameter specifies the peak or mode of the distribution while the scale parameter specifies the half-width at half-maximum of the distribution. In addition, the mean and variance of a cauchy or Lorentzian distribution are undefined. In addition, the cauchy distribution is the Student's t distribution with only 1 degree of freedom. This distribution is also constructed by taking the ratio of two standard normal distributions (normal distributions with a mean of zero and a variance of one) that are independent of one another. The input requirements are such that Location can be any value whereas Scale>0 and can be any positive value.

### Chi-Square Distribution

The chi-square distribution is a probability distribution used predominatly in hypothesis testing, and is related to the gamma distribution and the standard normal distribution. For instance, the sums of independent normal distributions are distributed as a chi-square (χ²) with k degrees of freedom:

Z₁²+Z₂²+ . . . +Zₖ²^{^{d}}˜χₖ²

The mathematical constructs for the chi-square distribution are as follows:

$$f ( x ) = \frac{{2}^{- k / 2}}{Γ ( k / 2 )} {x}^{k / 2 + 1} {e}^{- x / 2} for all x > 0$$

$$mean = k$$

$$standard deviation = \sqrt{2 k}$$

$$skewness = 2 \sqrt{\frac{2}{k}}$$

$$excess kurtosis = \frac{12}{k}$$

Γ is the gamma function. Degrees of freedom k is the only distributional parameter.

The chi-square distribution can also be modeled using a gamma distribution by setting the shape

$$parameter = \frac{k}{2} and scale = 2 {S}^{2}$$

where S is the scale. The input requirements are such that Degrees of freedom >1 and must be an integer<1000.

### Exponential Distribution

The exponential distribution is widely used to describe events recurring at random points in time, such as the time between failures of electronic equipment or the time between arrivals at a service booth. It is related to the Poisson distribution, which describes the number of occurrences of an event in a given interval of time. An important characteristic of the exponential distribution is the “memoryless” property, which means that the future lifetime of a given object has the same distribution, regardless of the time it existed. In other words, time has no effect on future outcomes. The mathematical constructs for the exponential distribution are as follows:

$$f ( x ) = λ {e}^{- λ x} for x \geq 0 ; λ > 0$$

$$mean = \frac{1}{λ}$$

$$standard deviation = \frac{1}{λ}$$

$$skewness = 2$$

$$( this value applies to all success rate λ inputs )$$

$$excess kurtosis = 6$$

$$( this value applies to all success rate λ inputs )$$

Success rate (λ) is the only distributional parameter. The number of successful trials is denoted x.

The condition underlying the exponential distribution is:
The exponential distribution describes the amount of time between occurrences. Input requirements: Rate>0 and≦300

### Extreme Value Distribution or Gumbel Distribution

The extreme value distribution (Type 1) is commonly used to describe the largest value of a response over a period of time, for example, in flood flows, rainfall, and earthquakes. Other applications include the breaking strengths of materials, construction design, and aircraft loads and tolerances. The extreme value distribution is also known as the Gumbel distribution. The mathematical constructs for the extreme value distribution are as follows:

$$f ( x ) = \frac{1}{β} z {e}^{- Z} where z = {e}^{\frac{x - m}{β}}$$

$$for β > 0 ; and any value of x and m$$

$$mean = m + 0.577215 β$$

$$standard deviation = \sqrt{\frac{1}{6} {π}^{2} {β}^{2}}$$

$$skewness = \frac{12 \sqrt{6} ( 1.2020569 )}{{π}^{3}} = 1.13955$$

$$( this applies for all value s of mode and scale )$$

$$excess kurtosis = 5.4$$

$$( this applies for all values of mode and scale )$$

Mode (m) and scale (β) are the distributional parameters. There are two standard parameters for the extreme value distribution: mode and scale. The mode parameter is the most likely value for the variable (the highest point on the probability distribution). The scale parameter is a number greater than 0. The larger the scale parameter, the greater the variance. The input requirements are such that Mode can be any value and Scale>0.

### F Distribution or Fisher-Snedecor Distribution

The F distribution, also known as the Fisher-Snedecor distribution, is another continuous distribution used most frequently for hypothesis testing. Specifically, it is used to test the statistical difference between two variances in analysis of variance tests and likelihood ratio tests. The F distribution with the numerator degree of freedom n and denominator degree of freedom m is related to the chi-square distribution in that:

$$\frac{{χ}_{n}^{2} / {n}^{d}}{{χ}_{m}^{2} / m} \sim {F}_{n , m}$$

$$or f ( x ) = \frac{Γ ( \frac{n + m}{2} ) {( \frac{n}{m} )}^{n / 2} {x}^{n / 2 - 1}}{Γ ( \frac{n}{2} ) {Γ ( \frac{m}{2} ) [ x ( \frac{n}{m} ) + 1 ]}^{( n + m ) / 2}}$$

$$mean = \frac{m}{m - 2}$$

$$standard deviation = \frac{2 {m}^{2} ( m + n - 2 )}{{n ( m - 2 )}^{2} ( m - 4 )} for all m > 4$$

$$skewness = \frac{2 ( m + 2 n - 2 )}{m - 6} \sqrt{\frac{2 ( m - 4 )}{n ( m + n - 2 )}}$$

$$excess kurtosis = \frac{\begin{matrix}12 ( - 16 + 20 m - 8 {m}^{2} + {m}^{3} + \\ 44 n - 32 mn + 5 {m}^{2} n - 22 {n}^{2} + 5 {mn}^{2}\end{matrix}}{n ( m - 6 ) ( m - 8 ) ( n + m - 2 )}$$

The numerator degree of freedom n and denominator degree of freedom m are the only distributional parameters. The input requirements are such that Degrees of freedom numerator and degrees of freedom denominator both >0 integers.

### Gamma Distribution (Erlang Distribution)

The gamma distribution applies to a wide range of physical quantities and is related to other distributions: lognormal, exponential, Pascal, Erlang, Poisson, and Chi-Square. It is used in meteorological processes to represent pollutant concentrations and precipitation quantities. The gamma distribution is also used to measure the time between the occurrence of events when the event process is not completely random. Other applications of the gamma distribution include inventory control, economic theory, and insurance risk theory.

The gamma distribution is most often used as the distribution of the amount of time until the rth occurrence of an event in a Poisson process. When used in this fashion, the three conditions underlying the gamma distribution are:
The number of possible occurrences in any unit of measurement is not limited to a fixed number.
The occurrences are independent. The number of occurrences in one unit of measurement does not affect the number of occurrences in other units.
The average number of occurrences must remain the same from unit to unit.

The mathematical constructs for the gamma distribution are as follows:

$$f ( x ) = \frac{{( \frac{x}{β} )}^{α - 1} {e}^{- \frac{x}{β}}}{Γ ( α ) β} with any value of α > 0 and β > 0$$

$$mean = α β$$

$$standard deviation = \sqrt{{αβ}^{2}}$$

$$skewness = \frac{2}{\sqrt{α}}$$

$$excess kurtosis = \frac{6}{α}$$

Shape parameter alpha (α) and scale parameter beta (β) are the distributional parameters, and Γ is the gamma function. When the alpha parameter is a positive integer, the gamma distribution is called the Erlang distribution, used to predict waiting times in queuing systems, where the Erlang distribution is the sum of independent and identically distributed random variables each having a memoryless exponential distribution. Setting n as the number of these random variables, the mathematical construct of the Erlang distribution is:

$$f ( x ) = \frac{{x}^{n - 1} {e}^{- x}}{( n - 1 ) !} for all x > 0$$

and all positive integers of n, where the input requirements are such that Scale Beta>0 and can be any positive value, Shape Alpha≧0.05 and any positive value, and Location can be any value.

### Logistic Distribution

The logistic distribution is commonly used to describe growth, that is, the size of a population expressed as a function of a time variable. It also can be used to describe chemical reactions and the course of growth for a population or individual.

The mathematical constructs for the logistic distribution are as follows:

$$f ( x ) = \frac{{e}^{\frac{μ - x}{α}}}{{α [ 1 + {e}^{\frac{μ - x}{α}} ]}^{2}} for any value of α and μ$$

$$mean = μ$$

$$standard deviation = \sqrt{\frac{1}{3} {π}^{2} {α}^{2}}$$

$$skewness = 0$$

$$( this applies to all mean and scale inputs )$$

$$excess kurtosis = 1.2$$

$$( this applies to all mean and scale inputs )$$

Mean (μ) and scale (α) are the distributional parameters. There are two standard parameters for the logistic distribution: mean and scale. The mean parameter is the average value, which for this distribution is the same as the mode, because this distribution is symmetrical. The scale parameter is a number greater than 0. The larger the scale parameter, the greater the variance. Input requirements:

Scale>0 and can be any positive value

Mean can be any value

Lognormal Distribution

The lognormal distribution is widely used in situations where values are positively skewed, for example, in financial analysis for security valuation or in real estate for property valuation, and where values cannot fall below zero. Stock prices are usually positively skewed rather than normally (symmetrically) distributed. Stock prices exhibit this trend because they cannot fall below the lower limit of zero but might increase to any price without limit. Similarly, real estate prices illustrate positive skewness and are lognormally distributed as property values cannot become negative.

The three conditions underlying the lognormal distribution are:
The uncertain variable can increase without limits but cannot fall below zero.
The uncertain variable is positively skewed, with most of the values near the lower limit.
The natural logarithm of the uncertain variable yields a normal distribution.

Generally, if the coefficient of variability is greater than 30 percent, use a lognormal distribution. Otherwise, use the normal distribution.

The mathematical constructs for the lognormal distribution are as follows:

$$f ( x ) = \frac{1}{x \sqrt{2 π} ln ( σ )} {e}^{- \frac{{[ ln ( x ) - ln ( μ ) ]}^{2}}{{2 [ ln ( σ ) ]}^{2}}}$$

$$for x > 0 ; μ > 0 and σ > 0$$

$$mean = exp ( μ + \frac{{σ}^{2}}{2} )$$

$$standard deviation = \sqrt{exp ( {σ}^{2} + 2 μ ) [ exp ( {σ}^{2} ) - 1 ]}$$

$$skewness = ⌊ \sqrt{exp ( {σ}^{2} ) - 1} ⌋ ( 2 + exp ( {σ}^{2} ) )$$

$$excess kurtosis = exp ( 4 {σ}^{2} ) + 2 exp ( 3 {σ}^{2} ) + 3 exp ( 2 {σ}^{2} ) - 6$$

Mean (μ) and standard deviation (δ) are the distributional parameters. The input requirements are such that Mean and Standard deviation are both >0 and can be any positive value. By default, the lognormal distribution uses the arithmetic mean and standard deviation. For applications for which historical data are available, it is more appropriate to use either the logarithmic mean and standard deviation, or the geometric mean and standard deviation.

### Normal Distribution

The normal distribution is the most important distribution in probability theory because it describes many natural phenomena, such as people's IQs or heights. Decision makers can use the normal distribution to describe uncertain variables such as the inflation rate or the future price of gasoline.

### Conditions

The three conditions underlying the normal distribution are:
Some value of the uncertain variable is the most likely (the mean of the distribution).
The uncertain variable could as likely be above the mean as it could be below the mean (symmetrical about the mean).
The uncertain variable is more likely to be in the vicinity of the mean than further away.

The mathematical constructs for the normal distribution are as follows:

$$f ( x ) = \frac{1}{\sqrt{2 π} σ} {e}^{- \frac{{( x - μ )}^{2}}{2 {σ}^{2}}} for all values of x and μ ;$$

$$while σ > 0$$

$$mean = μ$$

$$standard deviation = σ$$

$$skewness = 0$$

$$( this applies to all inputs of mean and standard deviation )$$

$$excess kurtosis = 0$$

$$( this applies to all inputs of mean and standard deviation )$$

Mean (μ) and standard deviation (δ) are the distributional parameters. The input requirements are such that Standard deviation>0 and can be any positive value and Mean can be any value.

### Pareto Distribution

The Pareto distribution is widely used for the investigation of distributions associated with such empirical phenomena as city population sizes, the occurrence of natural resources, the size of companies, personal incomes, stock price fluctuations, and error clustering in communication circuits.

The mathematical constructs for the pareto are as follows:

$$f ( x ) = \frac{β {L}^{β}}{{x}^{( 1 + β )}} for x > L$$

$$mean = \frac{β L}{β - 1}$$

$$standard deviation = \sqrt{\frac{β {L}^{2}}{{( β - 1 )}^{2} ( β - 2 )}}$$

$$skewness = \sqrt{\frac{β - 2}{β}} [ \frac{2 ( β + 1 )}{β - 3} ]$$

$$excess kurtosis = \frac{6 ( {β}^{3} + {β}^{2} - 6 β - 2 )}{β ( β - 3 ) ( β - 4 )}$$

Location (L) and shape (β) are the distributional parameters.

There are two standard parameters for the Pareto distribution: location and shape. The location parameter is the lower bound for the variable. After you select the location parameter, you can estimate the shape parameter. The shape parameter is a number greater than 0, usually greater than 1. The larger the shape parameter, the smaller the variance and the thicker the right tail of the distribution. The input requirements are such that Location>0 and can be any positive value while Shape>0.05.

### Student's t Distribution

The Student's t distribution is the most widely used distribution in hypothesis test. This distribution is used to estimate the mean of a normally distributed population when the sample size is small, and is used to test the statistical significance of the difference between two sample means or confidence intervals for small sample sizes.

The mathematical constructs for the t-distribution are as follows:

$$f ( t ) = \frac{Γ [ ( r + 1 ) / 2 ]}{\sqrt{r π} Γ [ r / 2 ]} {( 1 + {t}^{2} / r )}^{- ( r + 1 ) / 2}$$

$$mean = 0$$

$$( \begin{matrix}this applies to all degrees of freedom r except if the \\ distribution is shifted to another nonzero central location\end{matrix} )$$

$$standard deviation = \sqrt{\frac{r}{r - 2}}$$

$$skewness = 0$$

$$excess kurtosis = \frac{6}{r - 4} for all r > 4$$

$$where t = \frac{x - \overline{x}}{s} and Γ is the gamma function .$$

Degree of freedom r is the only distributional parameter. The t-distribution is related to the F-distribution as follows: the square of a value of t with r degrees of freedom is distributed as F with 1 and r degrees of freedom. The overall shape of the probability density function of the t-distribution also resembles the bell shape of a normally distributed variable with mean 0 and variance 1, except that it is a bit lower and wider or is leptokurtic (fat tails at the ends and peaked center). As the number of degrees of freedom grows (say, above 30), the t-distribution approaches the normal distribution with mean 0 and variance 1. The input requirements are such that Degrees of freedom≧1 and must be an integer.

### Triangular Distribution

The triangular distribution describes a situation where you know the minimum, maximum, and most likely values to occur. For example, you could describe the number of cars sold per week when past sales show the minimum, maximum, and usual number of cars sold.

### Conditions

The three conditions underlying the triangular distribution are:
The minimum number of items is fixed.
The maximum number of items is fixed.
The most likely number of items falls between the minimum and maximum values, forming a triangular-shaped distribution, which shows that values near the minimum and maximum are less likely to occur than those near the most-likely value.

The mathematical constructs for the triangular distribution are as follows:

$$f ( x ) = \{ \begin{matrix}\frac{2 ( x - Min )}{( Max - Min ) ( Likely - min )} for Min < x < Likely \\ \frac{2 ( Max - x )}{( Max - Min ) ( Max - Likely )} for \text{Likely} < x < Max\end{matrix} \\ mean = \frac{1}{3} ( Min + Likely + Max ) \\ standard deviation = \sqrt{\frac{1}{18} ( \begin{matrix}{Min}^{2} + {Likely}^{2} + {Max}^{2} - \\ Min Max - Min Likely - Max Likely\end{matrix} )} \\ skewness = \frac{( \begin{matrix}\sqrt{2} ( Min + Max - 2 Likely ) \\ ( 2 Min - Max - Likely ) ( Min - 2 Max + Likely )\end{matrix} )}{5 {( \begin{matrix}{Min}^{2} + {Max}^{2} + {Likely}^{2} - MinMax - \\ MinLikely - MaxLikely\end{matrix} )}^{3 / 2}} \\ excess kurtosis = - 0.6$$

Minimum (Min), most likely (Likely) and maximum (Max) are the distributional parameters and the input requirements are such that Min≦Most Likely≦Max and can take any value, Min<Max and can take any value.

### Uniform Distribution

With the uniform distribution, all values fall between the minimum and maximum and occur with equal likelihood.

The three conditions underlying the uniform distribution are:
The minimum value is fixed.
The maximum value is fixed.
All values between the minimum and maximum occur with equal likelihood.

The mathematical constructs for the uniform distribution are as follows:

$$f ( x ) = \frac{1}{Max - Min}$$

$$for all values such that Min < Max$$

$$mean = \frac{Min + Max}{2}$$

$$standard deviation = \sqrt{\frac{{( Max - Min )}^{2}}{12}}$$

$$skewness = 0$$

$$excess kurtosis = - 1.2$$

$$( this applies to all inputs of Min and Max )$$

Maximum value (Max) and minimum value (Min) are the distributional parameters. The input requirements are such that Min<Max and can take any value.

Weibull Distribution (Rayleigh Distribution)

The Weibull distribution describes data resulting from life and fatigue tests. It is commonly used to describe failure time in reliability studies as well as the breaking strengths of materials in reliability and quality control tests. Weibull distributions are also used to represent various physical quantities, such as wind speed. The Weibull distribution is a family of distributions that can assume the properties of several other distributions. For example, depending on the shape parameter you define, the Weibull distribution can be used to model the exponential and Rayleigh distributions, among others. The Weibull distribution is very flexible. When the Weibull shape parameter is equal to 1.0, the Weibull distribution is identical to the exponential distribution. The Weibull location parameter lets you set up an exponential distribution to start at a location other than 0.0. When the shape parameter is less than 1.0, the Weibull distribution becomes a steeply declining curve. A manufacturer might find this effect useful in describing part failures during a burn-in period.

The mathematical constructs for the Weibull distribution are as follows:

$$f ( x ) = {\frac{α}{β} [ \frac{x}{β} ]}^{α - 1} {e}^{- {( \frac{x}{β} )}^{α}}$$

$$mean = β Γ ( 1 + {α}^{- 1} )$$

$$standard deviation = {β}^{2} [ Γ ( 1 + 2 {α}^{- 1} ) - {Γ}^{2} ( 1 + {α}^{- 1} ) ]$$

$$skewness = \frac{\begin{matrix}2 {Γ}^{3} ( 1 + {β}^{- 1} ) - 3 Γ ( 1 + {β}^{- 1} ) Γ ( 1 + 2 {β}^{- 1} ) + \\ Γ ( 1 + 3 {β}^{- 1} )\end{matrix}}{{[ Γ ( 1 + 2 {β}^{- 1} ) - {Γ}^{2} ( 1 + {β}^{- 1} ) ]}^{3 / 2}}$$

$$excess kurtosis = \frac{\begin{matrix}- 6 {Γ}^{4} ( 1 + {β}^{- 1} ) + 12 {Γ}^{2} ( 1 + {β}^{- 1} ) Γ ( 1 + 2 {β}^{- 1} ) - \\ 3 {Γ}^{2} ( 1 + 2 {β}^{- 1} ) - 4 Γ ( 1 {\_β}^{- 1} ) Γ ( 1 + 3 {β}^{- 1} ) + \\ Γ ( 1 + 4 {β}^{- 1} )\end{matrix}}{{[ Γ ( 1 + 2 {β}^{- 1} ) - {Γ}^{2} ( 1 + {β}^{- 1} ) ]}^{2}}$$

Location (L), shape (α) and scale (β) are the distributional parameters, and Γ is the Gamma function. The input requirements are such that Scale>0 and can be any positive value, Shape≧0.05 and

Location can take on any value.

I claim:

1. A programmed computer system for modeling risk valuations for a financial institution, the system comprising:
a set of at least six hundred models including at least one of a: financial, forecasting, analytical, valuation, optimization and simulation model;
a set of at least twenty statistical and mathematical distributions used for simulation of model inputs and outputs;
an internal reduced gradient; and
search optimization algorithms used for portfolio optimization to obtain empirical solutions.

2. A method for extracting data from various existing databases, the method comprising:
applying proper analytics;
returning results;
accessing existing data;
data linking a required input parameter from an individual model;
mapping the input parameter to a variable in a database;
live linking an original file containing the existing data so as to update data in individual model when the proper analytics are applied;
at least one of: manually inputting an input variable into a matrix, and entering a single value to apply to an entire variable where a number of repetitions of the single value is determined based on a model type or other input variables;
computing inputs from other input processes;
manipulating data before passing the manipulated data into the individual model as a new variable;
interpreting string-based and fully context-sensitive expressions;
generating random values and using the random values to compute risk characteristics of the individual model;
fitting multiple data points from various input parameters against at least one statistical distribution and a hypothesis test coupled with optimization on each variable is run to determine the best-fitting distribution.

3. The method of claim 2, wherein at least one variable is linked and mapped to at least one of a: computed variable, and a fitted variable.

4. The method of claim 2, including the step of generating a profile with multiple models, each of the multiple models having input assumptions derived from at least one extracted source.

5. The method of claim 5, including the step of accessing at least one profile with at least one model to create a portfolio of valuation models.

6. A method of stochastic optimization, said method comprising:
combining a Monte Carlo simulation with optimization;
running a simulation of n trials to determine certain statistics;
extracting the statistics;
replacing at least one input variables; and
running an optimization of m iterations until a solution converges.

7. The method of claim 6, whereby the method is run t times; and whereby each decision variable in the optimization returns a distribution of outcomes.

8. A system for assessing risk, said system comprising:
a business logic layer to encapsulate a business process, a model, and data linking logic;
a data access layer to link to an existing database, said data access layer calling data back to the model for computation, and returning data;
a presentation layer to returns a computed result from said the business logic and said data access layers, back to a user.
